(19) United States
(12) Patent Application Publication
(10) Pub. No.: US 2023/0306489 A1
(43) Pub. Date: Sep. 28, 2023

(54) DATA ANALYSIS APPARATUS AND DATA ANALYSIS METHOD

(71) Applicant: HITACHI, LTD., Tokyo (JP)

(72) Inventors: Quan KONG, Tokyo (JP); Tomoaki YOSHINAGA, Tokyo (JP)

(21) Appl. No.: 18/039,097

(22) PCT Filed: Aug. 18, 2021
(86) PCT No.: PCT/JP2021/030257

§ 371 Date: May 26, 2023

(30) Foreign Application Priority Data
Nov. 30, 2020 (JP) 2020-198781

(51) Int. Cl. G06Q 30/0601; G06V 20/52; G06V 10/62; G06V 10/426; G06V 10/98; G06V 10/44

(52) U.S. Cl. CPC G06Q 30/0629; G06V 20/52; G06V 10/62; G06V 10/426; G06V 10/98; G06V 10/44

(57) ABSTRACT

A data analysis apparatus is provided with a graph data generation unit that generates, in chronological order, a plurality of items of graph data configured by combining a plurality of nodes representing attributes for each element and a plurality of edges representing relatedness between the plurality of nodes, a node feature vector extraction unit that extracts a node feature vector for each of the plurality of nodes, an edge feature vector extraction unit that extracts an edge feature vector for each of the plurality of edges, and a spatiotemporal feature vector calculation unit that calculates a spatiotemporal feature vector indicating a change in node feature vector by performing, on the plurality of items of graph data generated by the graph data generation unit, convolution processing for each of a space direction and a time direction on the basis of the node feature vector and the edge feature vector.

### TECHNICAL FIELD

The present invention pertains to an apparatus and method for performing predetermined data analysis.

### BACKGROUND ART

Conventionally, graph data analysis is known in which each element included in an analysis target is replaced by a node, the relatedness between respective nodes is represented by graph data, and this graph data is used to perform various analyses. Such graph data analysis is widely used in various fields such as an SNS (Social Networking Service), analysis of a purchase history or a transaction history, natural language search, sensor data log analysis, and moving image analysis, for example. Graph data analysis generates graph data representing the state of an analysis target by nodes and relatedness between nodes, and uses a feature vector extracted from this graph data to perform a predetermined computation process. As a result, it is possible to achieve analysis that reflects the coming and going of information between respective elements in addition to features of each element included in an analysis target.

In recent years, in relation to graph data analysis, a technique referred to as a GCN (Graph Convolutional Network) has been proposed. In a GCN, feature vectors for nodes and edges representing relatedness between respective nodes included in graph data are used to perform a convolution computation, whereby an effective feature vector is acquired from the graph data. Due to the appearance of this GCN technique, it has become possible to combine deep learning techniques with graph data analysis and, as a result, graph data analysis in accordance with an effective neural network model has been realized as a data-driven modeling method.

In relation to GCN, techniques described in Non-Patent Documents 1 and 2 are known. Non-Patent Document 1 discloses a spatiotemporal graph modeling technique in which skeleton information (joint positions) detected from a person is represented by nodes and the relatedness between adjacent nodes is defined as an edge, whereby an action pattern for the person is recognized. Non-Patent Document 2 discloses a technique in which traffic lights installed on a road are represented by nodes and an amount of traffic between traffic lights is defined as an edge, whereby a traffic state for the road is analyzed.

### PRIOR ART DOCUMENT

### Non-Patent Documents

Non-Patent Document 1: Sijie Yan, Yuanjun Xiong, Dahua Lin, “Spatial Temporal Graph Convolutional Networks for Skeleton-Based Action Recognition,” AAAI 2018

Non-Patent Document 2: Bing Yu, Haoteng Yin, Zhanxing Zhu, “Spatio-Temporal Graph Convolutional Networks: A Deep Learning Framework for Traffic Forecasting,” IJCAI 2018

### SUMMARY OF THE INVENTION

### Problem to be Solved by the Invention

With the techniques in Non-Patent Documents 1 and 2, it is necessary to preset the size of an adjacency matrix, which represents the relatedness between nodes, in alignment with the number of nodes on a graph. Accordingly, it is difficult to have application to a case in which the number of nodes or edges included in graph data changes in accordance with the passage of time. In this manner, conventional graph data analysis methods have a problem in that, in a case where the structure of graph data dynamically changes in a time direction, it is not possible to effectively obtain a change in node feature vector which corresponds thereto.

### Means for Solving the Problem

A data analysis apparatus according to the present invention is provided with a graph data generation unit configured to generate, in chronological order, a plurality of items of graph data configured by combining a plurality of nodes representing attributes for each element and a plurality of edges representing relatedness between the plurality of nodes, a node feature vector extraction unit configured to extract a node feature vector for each of the plurality of nodes, an edge feature vector extraction unit configured to extract an edge feature vector for each of the plurality of edges, and a spatiotemporal feature vector calculation unit configured to calculate a spatiotemporal feature vector indicating a change in the node feature vector by performing, on the plurality of items of graph data generated by the graph data generation unit, convolution processing for each of a space direction and a time direction on the basis of the node feature vector and the edge feature vector.

A data analysis method according to the present invention uses a computer to execute a process for generating, in chronological order, a plurality of items of graph data configured by combining a plurality of nodes representing attributes for each element and a plurality of edges representing relatedness between the plurality of nodes, a process for extracting a node feature vector for each of the plurality of nodes, a process for extracting an edge feature vector for each of the plurality of edges, and a process for calculating a spatiotemporal feature vector indicating a change in node feature vector by performing, on the plurality of items of graph data, convolution processing for each of a space direction and a time direction on the basis of the node feature vector and the edge feature vector.

### Advantages of the Invention

By virtue of the present invention, in a case where the structure of graph data dynamically changes in the time direction, it is possible to effectively obtain a change in node feature vector which corresponds thereto.

### BRIEF DESCRIPTION OF THE DRAWINGS

FIG. 1 is a block view that illustrates a configuration of an anomaly detection system (data analysis apparatus) according to a first embodiment of the present invention.

FIG. 2 depicts block views that illustrate a configuration of a graph data generation unit.

FIG. 3 is a view that illustrates an outline of processing performed by the graph data generation unit in the anomaly detection system according to the first embodiment of the present invention.

FIG. 4 is a view that illustrates an example of a data structure of a graph database.

FIG. 5 depicts views that illustrate an example of a data structure of a node database.

FIG. 6 is a view that illustrates an example of a data structure of an edge database.

FIG. 7 is a view for describing a graph data visualization editing unit.

FIG. 8 is a block view that illustrates a configuration of a node feature vector extraction unit.

FIG. 9 is a view that illustrates an outline of processing performed by the node feature vector extraction unit.

FIG. 10 is a block view that illustrates a configuration of an edge feature vector extraction unit.

FIG. 11 is a block view that illustrates a configuration of a spatiotemporal feature vector calculation unit.

FIG. 12 is a view that illustrates an example of an equation that represents a computation process in the spatiotemporal feature vector calculation unit.

FIG. 13 is a view that illustrates an outline of processing performed by the spatiotemporal feature vector calculation unit.

FIG. 14 is a block view that illustrates a configuration of an anomaly detection unit.

FIG. 15 is a view that illustrates an outline of processing performed by the anomaly detection unit.

FIG. 16 is a block view that illustrates a configuration of a determination ground presentation unit.

FIG. 17 depicts views that illustrate an outline of processing performed by a ground confirmation target selection unit and a subgraph extraction processing unit.

FIG. 18 is a view that illustrates an example of an anomaly detection screen displayed by the determination ground presentation unit.

FIG. 19 is a block view that illustrates a configuration of a sensor failure estimation system (data analysis apparatus) according to a second embodiment of the present invention.

FIG. 20 is a view that illustrates an outline of processing performed by the graph data generation unit in the sensor failure estimation system according to the second embodiment of the present invention.

FIG. 21 is a view that illustrates an outline of processing performed by the spatiotemporal feature vector calculation unit and a failure rate prediction unit in the sensor failure estimation system according to the second embodiment of the present invention.

FIG. 22 is a block view that illustrates a configuration of a financial risk management system (data analysis apparatus) according to a third embodiment of the present invention.

FIG. 23 is a view that illustrates an outline of processing performed by the graph data generation unit in the financial risk management system according to the third embodiment of the present invention.

FIG. 24 is a view that illustrates an outline of processing performed by the spatiotemporal feature vector calculation unit and a financial risk estimation unit in the financial risk management system according to the third embodiment of the present invention.

### MODES FOR CARRYING OUT THE INVENTION

Embodiments of the present invention are described below with reference to the drawings. In order to clarify the description, the following description and the drawings are omitted and simplified as appropriate. The present invention is not limited to the embodiments, and every possible example of application that matches the idea of the present invention is included in the technical scope of the present invention. Unless otherwise specified, components may be singular or plural.

In the following description, various items of information may be described by expressions including “xxx table,” for example, but the various items of information may be expressed as data structures other than tables. In order to indicate that various items of information do not depend on a data structure, “xxx table” may be referred to as “xxx information.”

In addition, in the following description, it may be that, in a case where description is given without distinguishing elements of the same kind, a reference symbol (or a common portion from among reference symbols) is used and, in a case where description is given while distinguishing elements of the same kind, an ID for the element (or a reference symbol for the element) is used.

In addition, in the following description, processing may be described using a “program” or a process therefor as the subject, but because the program is executed by a processor (for example, a CPU (Central Processing Unit)) to perform defined processing while appropriately using a storage resource (for example, a memory) and/or a communication interface device (for example, a communication port), description may be given with the processor as the subject for the processing. A processor operates in accordance with a program to thereby operate as a functional unit for realizing a predetermined function. An apparatus and system that includes the processor are an apparatus and system that include such functional units.

### First Embodiment

Description is given below regarding a first embodiment of the present invention.

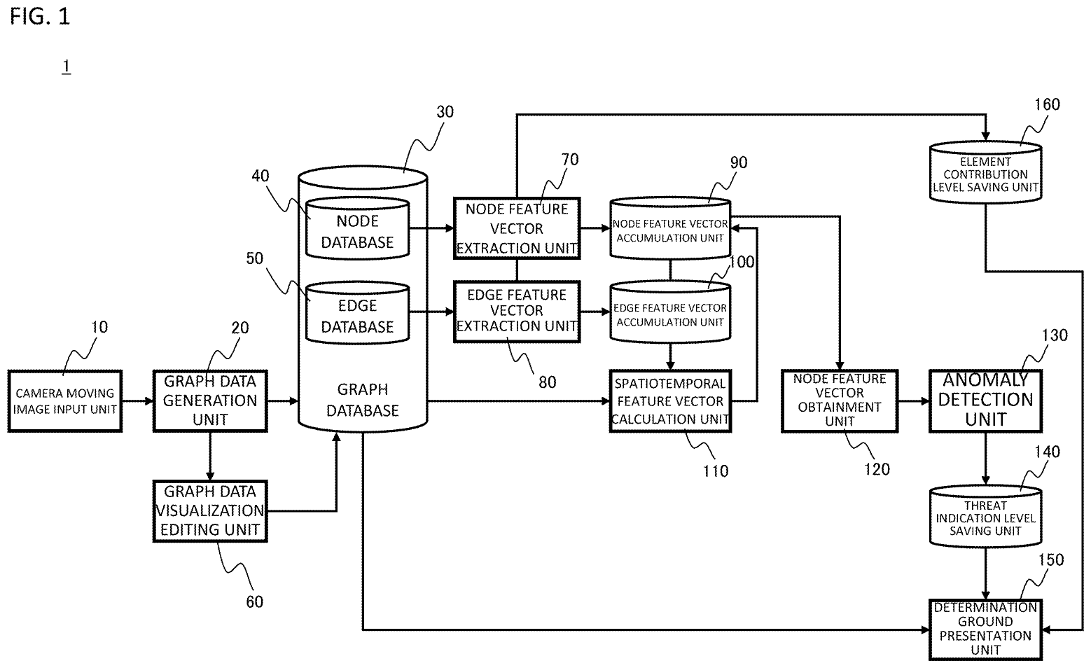

FIG. 1 is a block view that illustrates a configuration of an anomaly detection system according to the first embodiment of the present invention. An anomaly detection system 1 according to the present embodiment, on the basis of a video or image obtained by a surveillance camera capturing a predetermined location to be monitored, detects, as an anomaly, a threat occurring in the location to be monitored or an indication for such a threat. Note that a video or image used in the anomaly detection system 1 is a video or moving image captured at a predetermined frame rate by the surveillance camera, and such videos and moving images are all configured by a combination of a plurality of images obtained in chronological order. Description is given below by collectively referring to videos or images handled by the anomaly detection system 1 as simply “videos.”

As illustrated in FIG. 1, the anomaly detection system 1 is configured by being provided with a camera moving image input unit 10, a graph data generation unit 20, a graph database 30, a graph data visualization editing unit 60, a node feature vector extraction unit 70, an edge feature vector extraction unit 80, a node feature vector accumulation unit 90, an edge feature vector accumulation unit 100, a spatiotemporal feature vector calculation unit 110, a node feature vector obtainment unit 120, an anomaly detection unit 130, a threat indication level saving unit 140, a determination ground presentation unit 150, and an element contribution level saving unit 160. In the anomaly detection system 1, each functional block, that is, the camera moving image input unit 10, the graph data generation unit 20, the graph data visualization editing unit 60, the node feature vector extraction unit 70, the edge feature vector extraction unit 80, the spatiotemporal feature vector calculation unit 110, the node feature vector obtainment unit 120, the anomaly detection unit 130, or the determination ground presentation unit 150, is, for example, realized by a computer executing a predetermined program, and the graph database 30, the node feature vector accumulation unit 90, the edge feature vector accumulation unit 100, the threat indication level saving unit 140, and the element contribution level saving unit 160 are realized using a storage device such as an HDD (Hard Disk Drive) or an SSD (Solid State Drive). Note that some or all of these functional blocks may be realized using a GPU (Graphics Processing Unit) or an FPGA (Field Programmable Gate Array).

The camera moving image input unit 10 obtains data regarding a video (moving image) captured by an unillustrated surveillance camera, and inputs the data to the graph data generation unit 20.

The graph data generation unit 20, on the basis of video data inputted from the camera moving image input unit 10, extracts one or more elements to be monitored from various photographic subjects appearing in the video, and generates graph data that represents an attribute for each element and relatedness between elements. Here, an element to be monitored extracted in the graph data generation unit 20 is, from among various people or objects appearing in the video captured by the surveillance camera, a person or object that is moving or stationary at a location to be monitored where the surveillance camera is installed. However, it is desirable to exclude, inter alia, an object that is permanently installed at the location to be monitored or a building where the location to be monitored is present, from elements to be monitored.

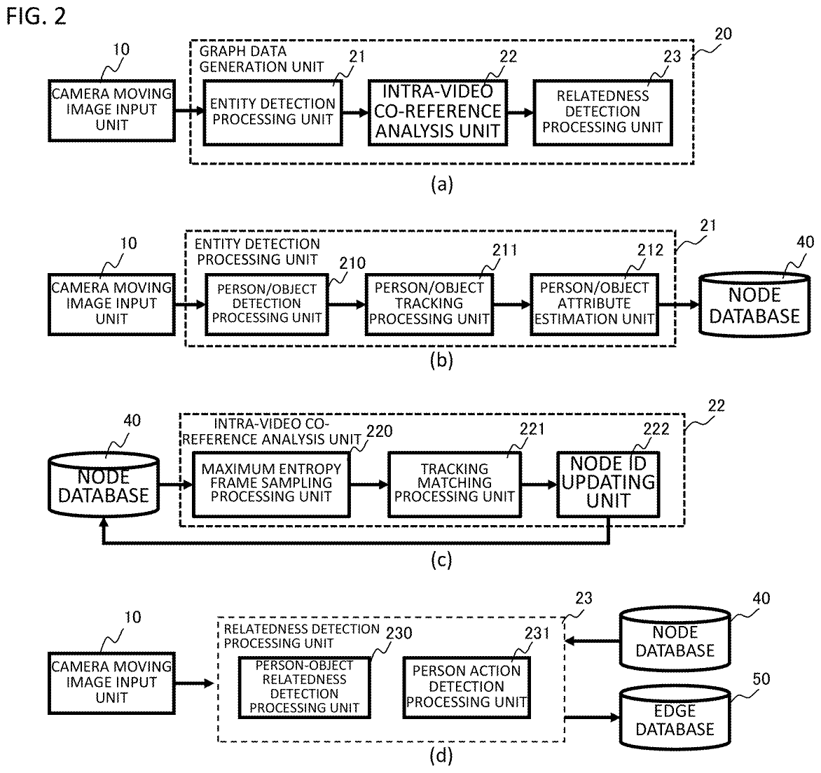

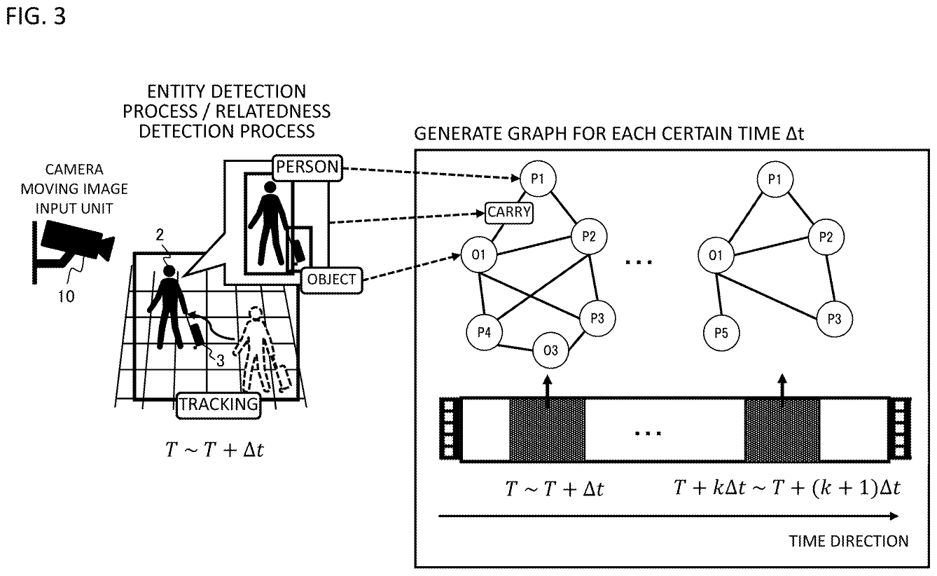

The graph data generation unit 20 divides time-series video data every predetermined time section At to thereby set a plurality of time ranges for the video, and generates graph data for each of these time ranges. Each generated item of graph data is recorded to the graph database 30 and also outputted to the graph data visualization editing unit 60. Note that details of the graph data generation unit 20 are described later with reference to FIG. 2 and FIG. 3.

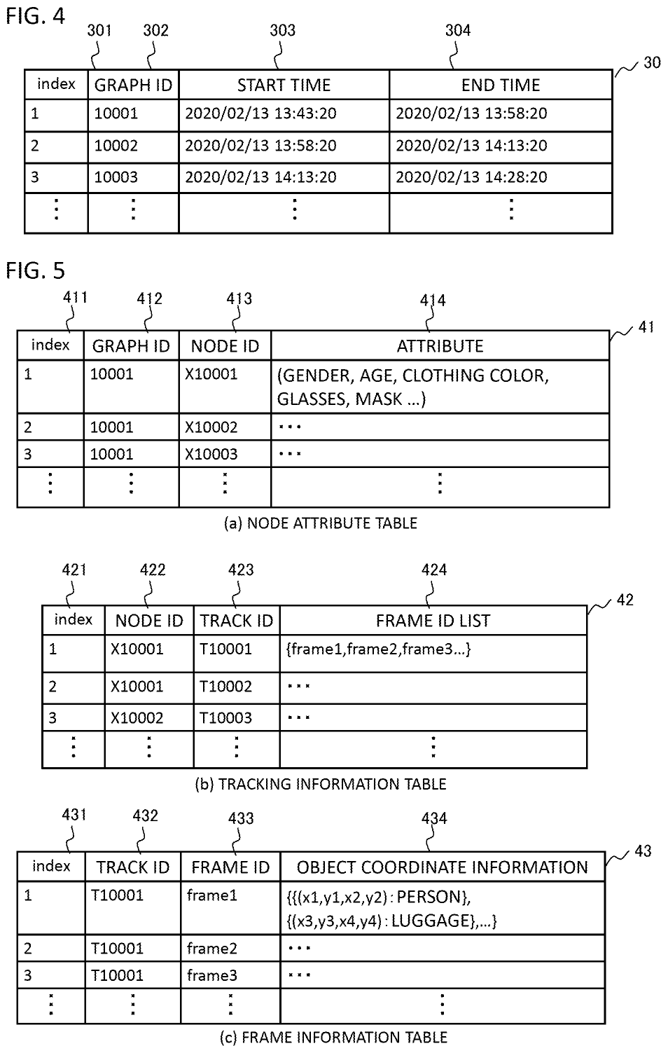

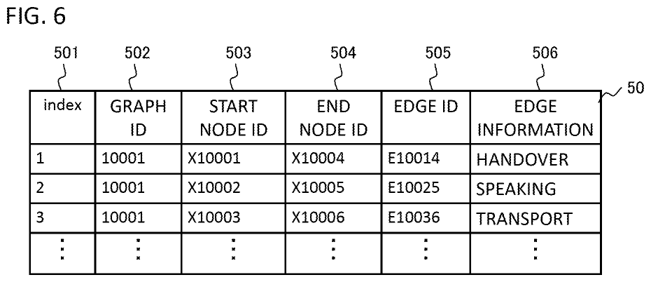

Graph data generated by the graph data generation unit 20 is stored to the graph database 30. The graph database 30 has a node database 40 and an edge database 50. Node data representing attributes for each element in graph data is stored in the node database 40, and edge data representing relatedness between respective elements in the graph data is stored in the edge database 50. Note that details of the graph database 30, the node database 40, and the edge database 50 are described later with reference to FIG. 4, FIG. 5, and FIG. 6.

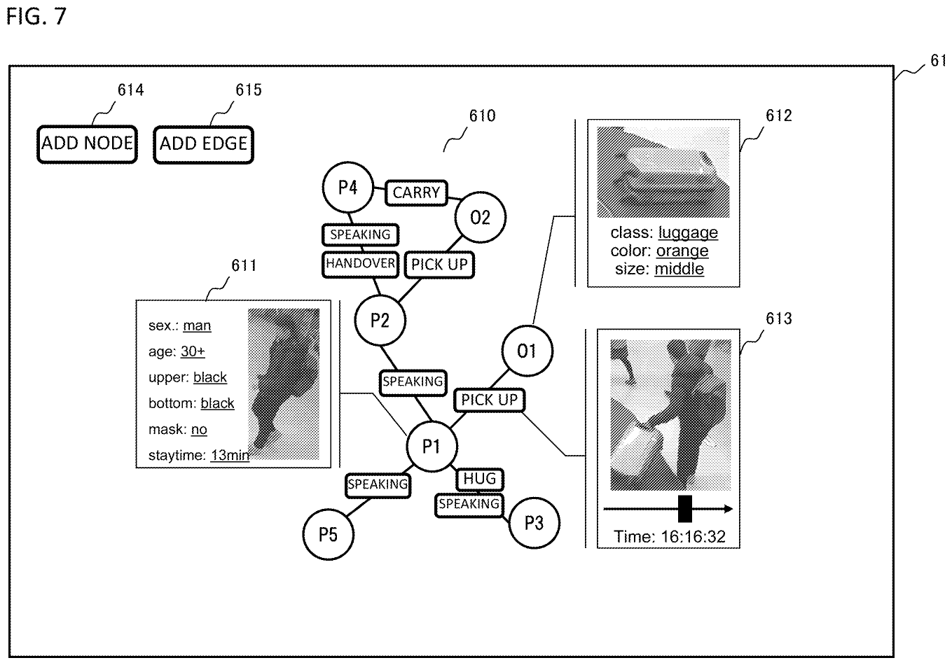

The graph data visualization editing unit 60 visualizes graph data generated by the graph data generation unit 20, presents the visualized graph data to a user, and accepts editing of graph data by a user. Edited graph data is stored to the graph database 30. Note that details of the graph data visualization editing unit 60 are described later with reference to FIG. 7.

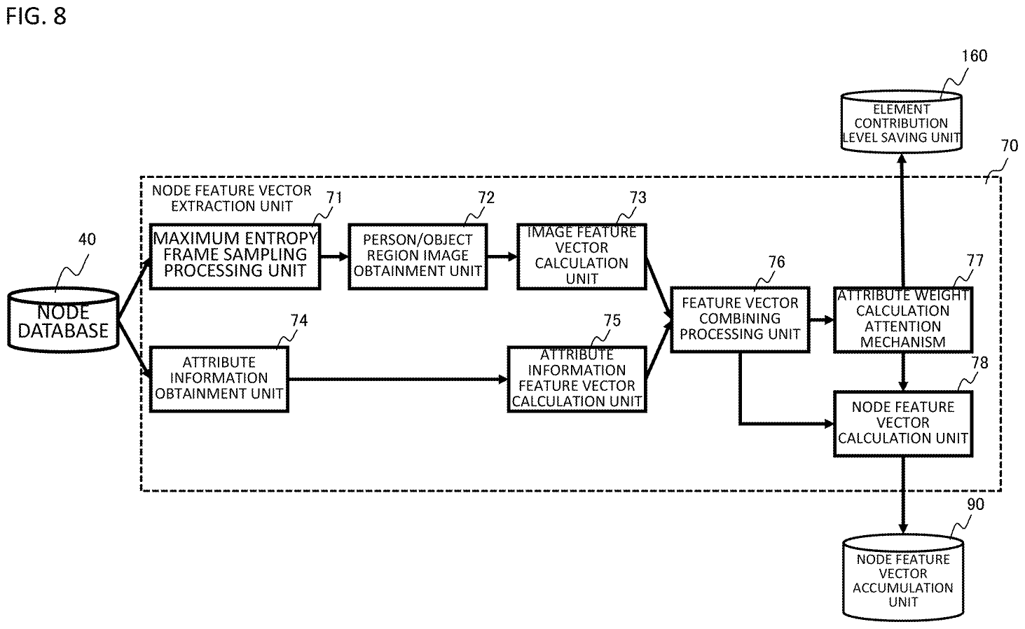

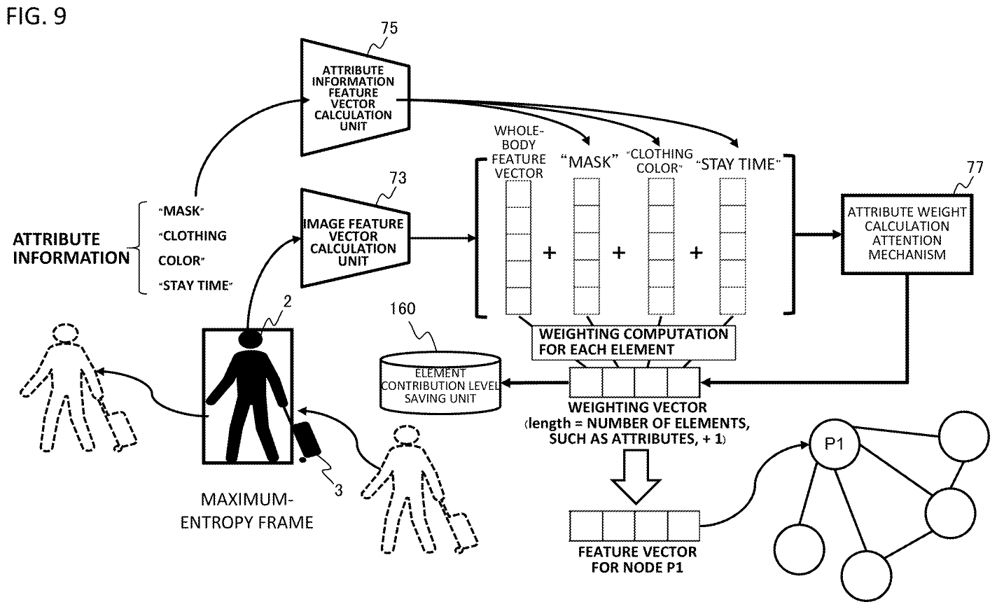

The node feature vector extraction unit 70 extracts a node feature vector for each item of graph data, on the basis of node data stored in the node database 40. A node feature vector extracted by the node feature vector extraction unit 70 numerically expresses a feature held by an attribute for each element in each item of graph data, and is extracted for each node included in each item of graph data. The node feature vector extraction unit 70 stores information regarding an extracted node feature vector in the node feature vector accumulation unit 90 while also storing a weight used to calculate the node feature vector in the element contribution level saving unit 160. Note that details of the node feature vector extraction unit 70 are described later with reference to FIG. 8 and FIG. 9.

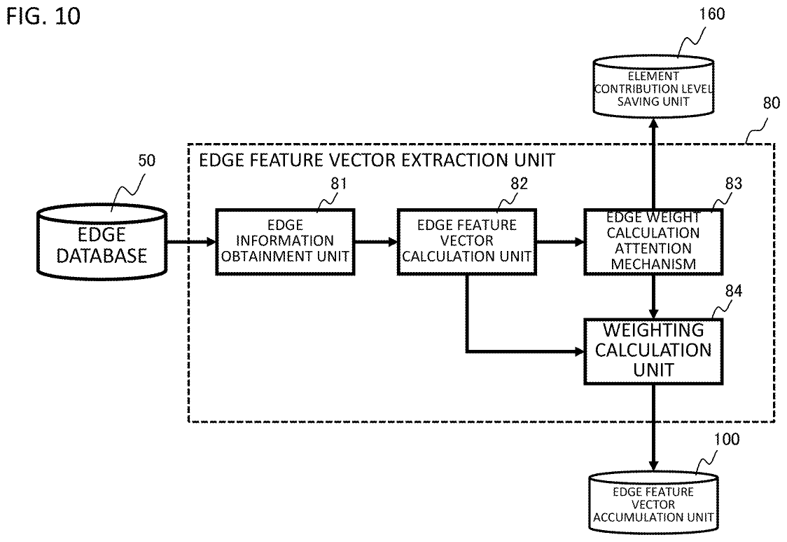

The edge feature vector extraction unit 80 extracts an edge feature vector for each item of graph data, on the basis of edge data stored in the edge database 50. An edge feature vector extracted by the edge feature vector extraction unit 80 numerically expresses a feature held by the relatedness between elements in each item of graph data, and is extracted for each edge included in each item of graph data. The edge feature vector extraction unit 80 stores information regarding an extracted edge feature vector to the edge feature vector accumulation unit 100 while also storing a weight used to calculate the edge feature vector to the element contribution level saving unit 160. Note that details of the edge feature vector extraction unit 80 are described later with reference to FIG. 10.

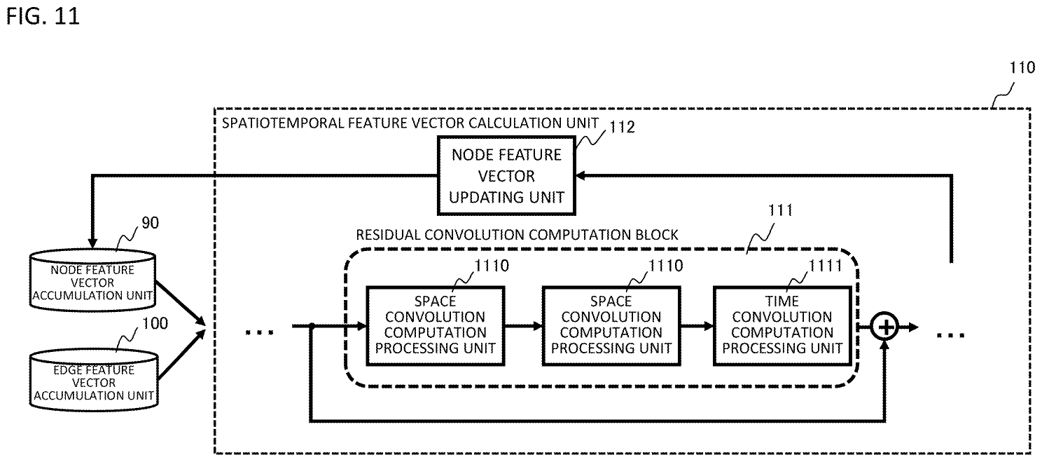

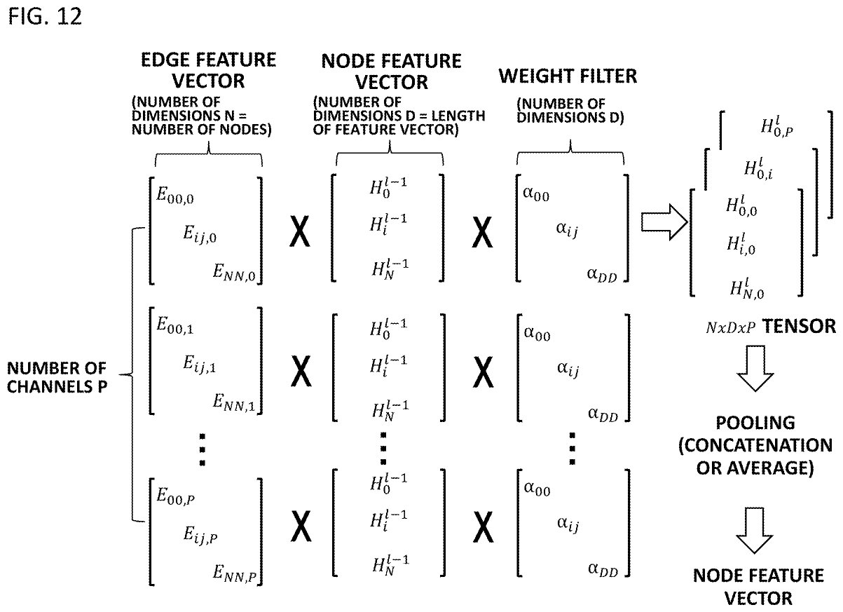

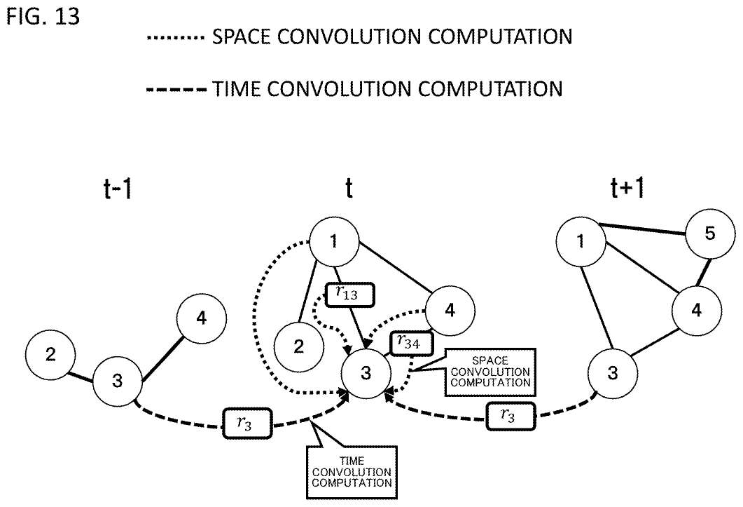

The spatiotemporal feature vector calculation unit 110 calculates a spatiotemporal feature vector for graph data, on the basis of node feature vectors and edge feature vectors for each graph that are respectively accumulated in the node feature vector accumulation unit 90 and the edge feature vector accumulation unit 100. A spatiotemporal feature vector calculated by the spatiotemporal feature vector calculation unit 110 numerically expresses temporal and spatial features for each item of graph data generated for each predetermined time section At with respect to time-series video data in the graph data generation unit 20, and is calculated for each node included in each item of graph data. With respect to node feature vectors accumulated for respective nodes, the spatiotemporal feature vector calculation unit 110 performs convolution processing that is to be applied by individually weighting a feature vector for another node in an adjacent relation with the respective node and a feature vector for an edge set between these adjacent nodes, in each of a space direction and a time direction. Such convolution processing is repeated a plurality of times, whereby it is possible to calculate a spatiotemporal feature vector that reflects latent relatedness with respect to an adjacent node, to feature vectors for respective nodes. The spatiotemporal feature vector calculation unit 110 updates node feature vectors accumulated in the node feature vector accumulation unit 90 by reflecting calculated spatiotemporal feature vectors. Note that details of the spatiotemporal feature vector calculation unit 110 are described later with reference to FIG. 11, FIG. 12, and FIG. 13.

The node feature vector obtainment unit 120 obtains a node feature vector which has been accumulated in the node feature vector accumulation unit 90 and to which the spatiotemporal feature vector calculated by the spatiotemporal feature vector calculation unit 110 has been reflected, and inputs the node feature vector to the anomaly detection unit 130.

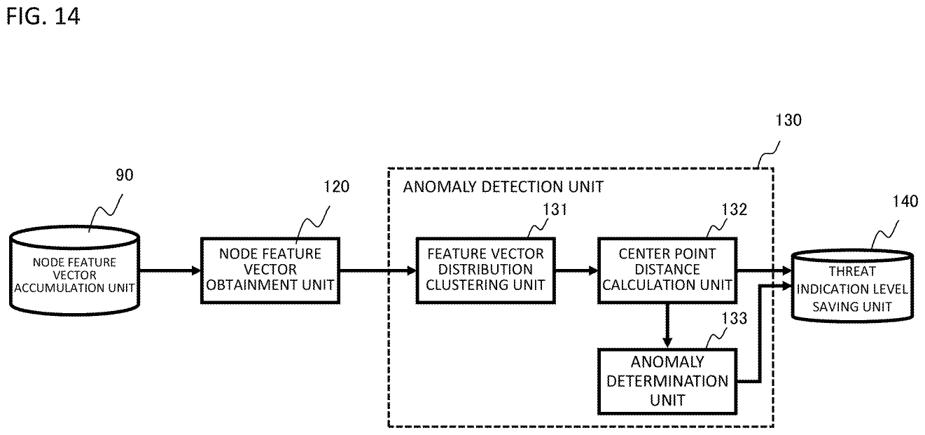

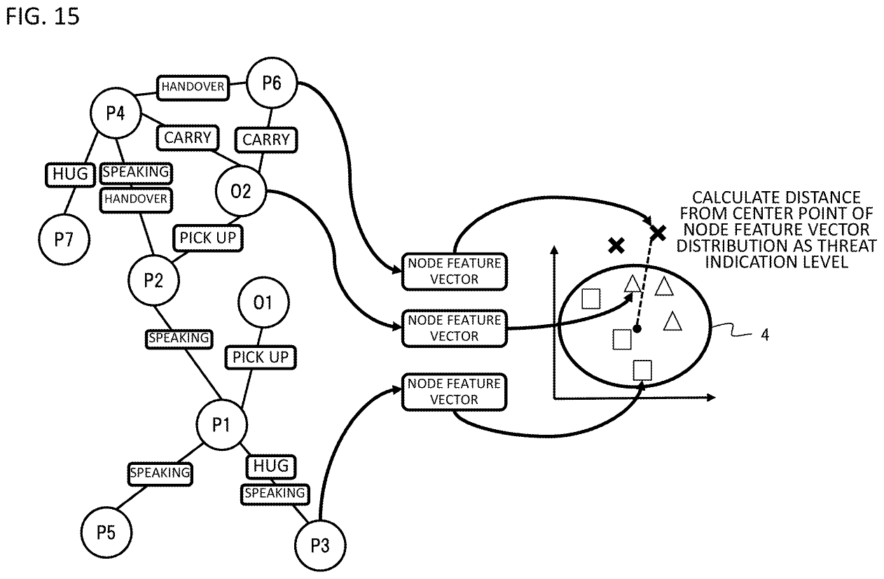

On the basis of the node feature vector inputted from the node feature vector obtainment unit 120, the anomaly detection unit 130 calculates a threat indication level for each element appearing in a video captured by the surveillance camera. A threat indication level is a value indicating a degree that an action by or a feature of a person or object corresponding to a respective element is considered to correspond to a threat such as a crime or an act of terrorism, or an indication therefor. In a case where a person performing a suspicious action or a suspicious item is present, this is detected on the basis of a result of calculating the threat indication level for each element. Here, as described above, the spatiotemporal feature vector calculated by the spatiotemporal feature vector calculation unit 110 has been reflected to a node feature vector inputted from the node feature vector obtainment unit 120. In other words, the anomaly detection unit 130 calculates the threat indication level for each element on the basis of the spatiotemporal feature vector calculated by the spatiotemporal feature vector calculation unit 110, whereby an anomaly at the monitoring location where the surveillance camera is installed is detected. The anomaly detection unit 130 stores the threat indication level calculated for each element and an anomaly detection result in the threat indication level saving unit 140. Note that details of the anomaly detection unit 130 are described later with reference to FIG. 14 and FIG. 15.

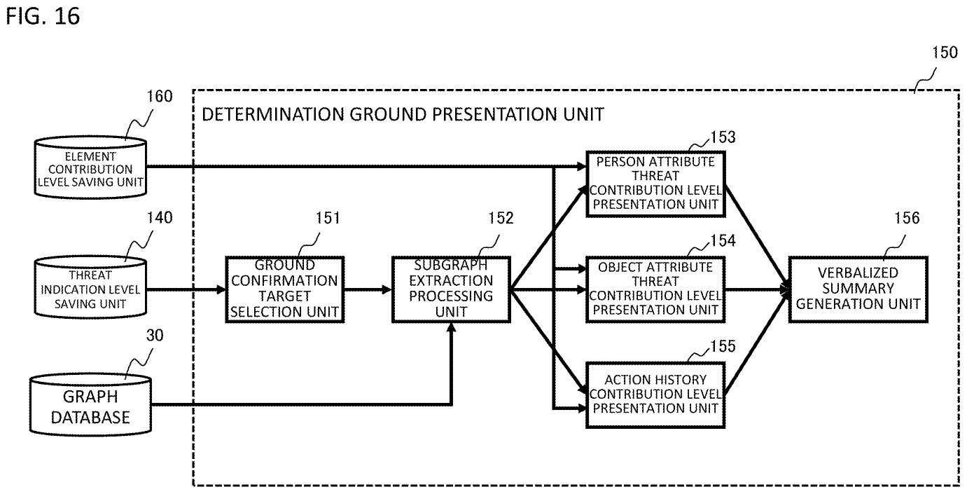

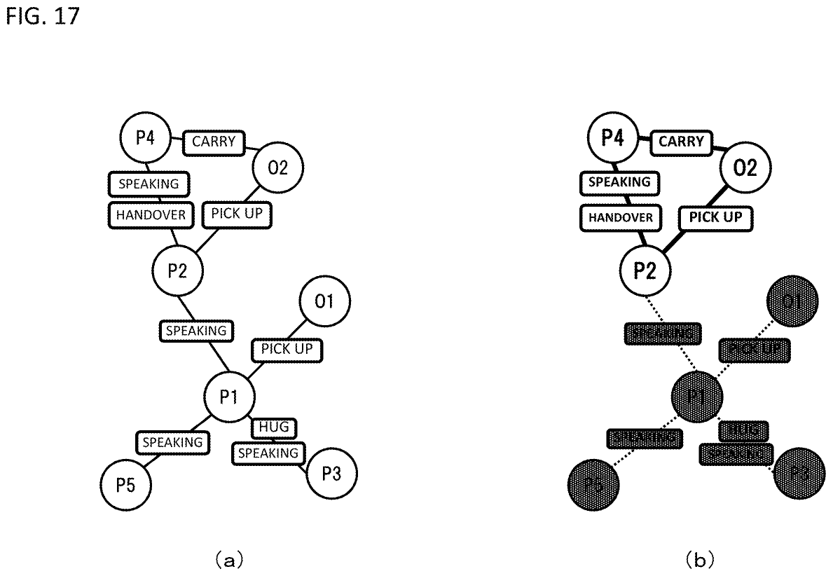

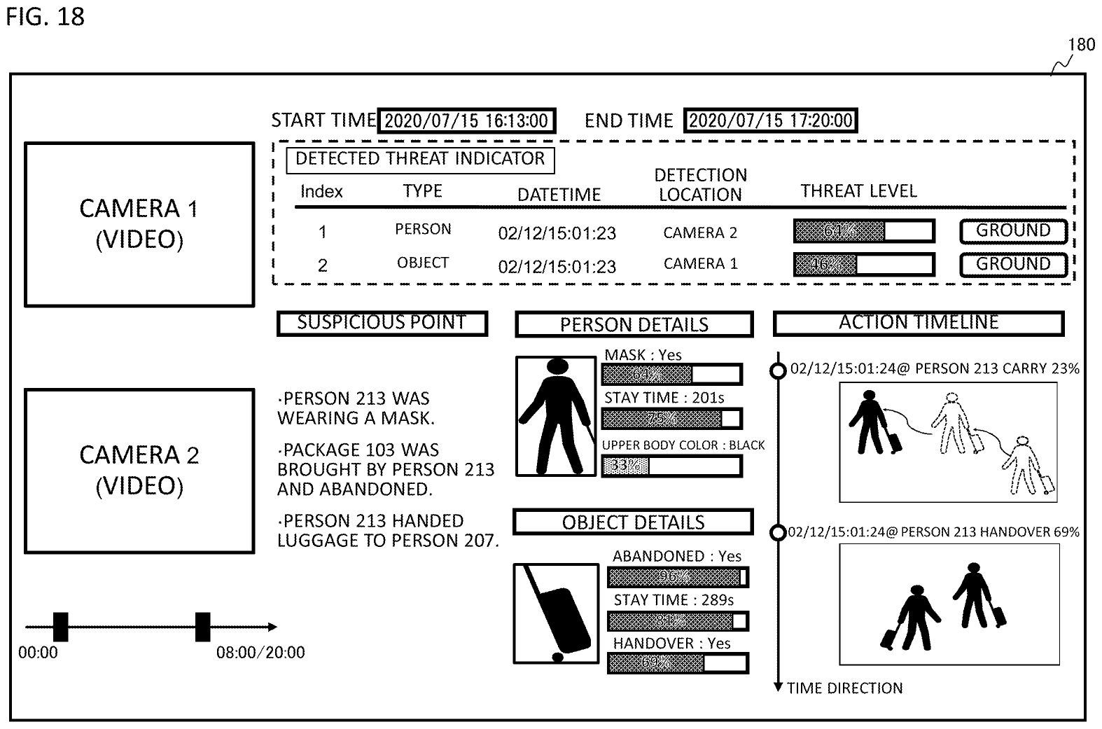

The determination ground presentation unit 150, on the basis of each item of graph data stored in the graph database 30, the threat indication level for each element in each item of graph data stored in the threat indication level saving unit 140, and weighting coefficients that are stored in the element contribution level saving unit 160 and are for times of calculating node feature vectors and edge feature vectors, presents a user with an anomaly detection screen indicating a result of processing by the anomaly detection system 1. This anomaly detection screen includes information regarding a person or object detected as a suspicious person or a suspicious item by the anomaly detection unit 130, while also including information indicating a ground indicating why the anomaly detection unit 130 has made this determination. By viewing the anomaly detection screen presented by the determination ground presentation unit 150, a user can confirm which person or object has been detected as a suspicious person or suspicious item from among various people or objects appearing in the video, as well as due to what kind of reason the detection has been performed. Note that details of the determination ground presentation unit 150 are described later with reference to FIG. 16, FIG. 17, and FIG. 18.

Next, details of each functional block described above are described below.

FIG. 2 depicts block views that illustrate a configuration of the graph data generation unit 20. As illustrated in FIG. 2(a), the graph data generation unit 20 is configured by being provided with an entity detection processing unit 21, an intra-video co-reference analysis unit 22, and a relatedness detection processing unit 23.

The entity detection processing unit 21 performs an entity detection process with respect to video data inputted from the camera moving image input unit 10. The entity detection process performed by the entity detection processing unit 21 detects a person or object corresponding to an element to be monitored from the video, and estimates an attribute for each element. As illustrated in FIG. 2(b), the entity detection processing unit 21 is provided with a person/object detection processing unit 210, a person/object tracking processing unit 211, and a person/object attribute estimation unit 212.

The person/object detection processing unit 210, for each time range resulting from dividing time-series video data every predetermined time section At, uses a predetermined algorithm or tool (for example, OpenCV, Faster R-CNN, or the like) to detect a person or object appearing within the video as an element to be monitored. A unique ID is assigned as a node ID to each detected element, a frame that surrounds a region within the video for a respective element is set, and frame information pertaining to the position or size of this frame is obtained.

The person/object tracking processing unit 211, on the basis of frame information that is for each element and is obtained by the person/object detection processing unit 210, uses a predetermined object tracking algorithm or tool (for example, Deepsort or the like) to perform a tracking process for each element in the time-series video data. Tracking information indicating a result of the tracking process for each element is obtained and is linked to the node IDs for respective elements.

The person/object attribute estimation unit 212 performs attribute estimation for each element on the basis of the tracking information that is for each element and is obtained by the person/object tracking processing unit 211. Here, an entropy is calculated for each frame extracted by sampling the video data at a predetermined sampling rate (for example, 1 fps), for example. For example, letting the reliability of a detection result for each frame be p, the entropy for each frame is calculated by (p∈{0, 1}), H=plog(1−p). Image information for a person or object in the frame having the highest calculated value for entropy is used to perform attribute estimation for each element. Estimation of an attribute is, for example, performed using an attribute estimation model trained in advance, and estimation is performed for apparent or behavioral features for a person or object, such as gender, age, clothing, whether wearing a mask or not, size, color, or stay time, for example. Once it has been possible to estimate attributes for each element, the attribute information is associated with the node ID of each element.

In the entity detection processing unit 21, the processing for each block described above is used to detect each of various people or objects appearing in a video as elements to be monitored, features for each person or each object are obtained as attributes for each element, and a unique node ID is assigned to each element. Tracking information or attribute information for each element is set in association with the node ID. These items of information are stored in the node database 40 as node data representing features for each element.

The intra-video co-reference analysis unit 22 performs intra-video co-reference analysis with respect to node data obtained by the entity detection processing unit 21. The intra-video co-reference analysis performed by the intra-video co-reference analysis unit 22 is a process for mutually referring to images for respective frames within a video to thereby correct node IDs assigned to respective elements in the node data. In the entity detection process performed by the entity detection processing unit 21, there are cases where a different node ID is erroneously assigned to the same person or object, and the frequency of this occurring changes due to algorithm performance. The intra-video co-reference analysis unit 22 performs intra-video co-reference analysis to thereby correct such node ID errors. As illustrated in FIG. 2(c), the intra-video co-reference analysis unit 22 is provided with a maximum entropy frame sampling processing unit 220, a tracking matching processing unit 221, and a node ID updating unit 222.

The maximum entropy frame sampling processing unit 220 samples a frame having the highest entropy value in video data, and reads out the node data for each element detected in this frame from the node database 40. On the basis of the read-out node data, image regions corresponding to each element within the image for the frame are extracted, whereby a template image for each element is obtained.

The tracking matching processing unit 221 performs template matching between respective frames on the basis of template images obtained by the maximum entropy frame sampling processing unit 220 and the tracking information included in node data that is for each element and is read out from the node database 40. Here, in what range each element is present in each frame image is estimated from the tracking information, and template matching using a template image within the estimated image range is performed.

The node ID updating unit 222 updates the node IDs assigned to respective elements, on the basis of a result of the template matching for each element performed by the tracking matching processing unit 221. Here, a common node ID is assigned to an element matched to mutually the same person or object among a plurality of frames by the template matching to thereby make node data that is for respective elements and is stored in the node database 40 be consistent. The node data that has been made consistent is divided every certain time section At, attribute information and tracking information are individually divided, and a node ID is associated with each element, whereby node data for respective elements in graph data for each time range set at intervals of the time section At is generated. The node data generated in this manner is stored in the node database 40 together with a graph ID that is uniquely set for each item of graph data.

The relatedness detection processing unit 23, on the basis of node data for which node IDs have been updated by the intra-video co-reference analysis unit 22, performs a relatedness detection process on video data inputted from the camera moving image input unit 10. The relatedness detection process performed by the relatedness detection processing unit 23 is for detecting mutual relatedness with respect to people or objects detected as elements to be monitored by the entity detection processing unit 21. As illustrated in FIG. 2(d), the relatedness detection processing unit 23 is provided with a person-object relatedness detection processing unit 230 and a person action detection processing unit 231.

The person-object relatedness detection processing unit 230, on the basis of node data for respective elements read from the node database 40, detects relatedness between a person and an object appearing in the video. Here, for example, a person-object relatedness detection model that has been trained in advance is used to detect an action such as “carry,” “open,” or “abandon” that a person performs with respect to an object such as luggage, as the relatedness between the two.

The person action detection processing unit 231, on the basis of node data for respective elements read from the node database 40, detects an interaction action between people appearing in the video. Here, for example, a person interaction action detection model that has been trained in advance is used to detect, as an interaction action between respective people, an action such as “conversation” or “handover” that a plurality of people perform together.

In the relatedness detection processing unit 23, in accordance with the processes for each block described above and in relation to people or objects detected as elements to be monitored by the entity detection processing unit 21, an action performed by a certain person with respect to another person or an object is detected, and this action is obtained as mutual relatedness. This information is stored in the edge database 50 as edge data that represents relatedness between respective elements.

FIG. 3 is a view that illustrates an outline of processing performed by the graph data generation unit 20 in the anomaly detection system 1 according to the first embodiment of the present invention. As illustrated in FIG. 3, the graph data generation unit 20 uses the entity detection process performed by the entity detection processing unit 21 to detect a person 2 and an object 3 being transported by the person 2 from a video captured by the camera moving image input unit 10, and tracks these within the video. In addition, the relatedness detection process performed by the relatedness detection processing unit 23 is used to detect the relatedness between the person 2 and the object 3. On the basis of these processing results, graph data that includes a plurality of nodes and edges is generated every certain time section At. In this graph data, for example, the person 2 is represented as a node P1, the object 3 is represented as a node O1, and attribute information indicating a feature thereof is set to each of these nodes. In addition, an edge called “carry” indicating the relatedness between the person 2 and the object 3 is set between the node P1 and the node O1. Information regarding graph data generated in this manner is stored in the graph database 30.

FIG. 4 is a view that illustrates an example of a data structure of the graph database 30. As illustrated in FIG. 4, the graph database 30 is represented as a data table that includes columns 301 through 304, for example. The column 301 stores a series of reference numbers that are set with respect to respective rows in the data table. The column 302 stores graph IDs that are specific to respective items of graph data. The columns 303 and 304 respectively store a start time and an end time for time ranges corresponding to respective items of graph data. Note that the start time and the end time are respectively calculated from an image capturing start time and an image capturing end time recorded in a video used to generate each item of graph data, and the difference therebetween is equal to the time section At described above. These items of information are stored in each row for each item of graph data, whereby the graph database 30 is configured.

FIG. 5 depicts views that illustrate an example of the data structure of the node database 40. The node database 40 is configured by a node attribute table 41 illustrated in FIG. 5(a), a tracking information table 42 illustrated in FIG. 5(b), and a frame information table 43 illustrated in FIG. 5(c).

As illustrated in FIG. 5(a), the node attribute table 41 is represented by a data table that includes columns 411 through 414, for example. The column 411 stores a series of reference numbers that are set with respect to respective rows in the data table. The column 412 stores a graph ID for graph data to which each node belongs. A value for this graph ID is associated with a value for a graph ID stored in the column 302 in the data table in FIG. 4 and, as a result, respective nodes and graph data are associated. The column 413 stores node IDs that are specific to respective nodes. The column 414 stores attribute information obtained for elements represented by respective nodes. These items of information are stored in each row for each node, whereby the node attribute table 41 is configured.

As illustrated in FIG. 5(b), the tracking information table 42 is represented by a data table that includes columns 421 through 424, for example. The column 421 stores a series of reference numbers that are set with respect to respective rows in the data table. The column 422 stores a node ID for a node set as a tracking target by respective items of tracking information. A value for this node ID is associated with a value for a node ID stored in the column 413 in the data table in FIG. 5(a) and, as a result, respective items of tracking information and nodes are associated. The column 423 stores track IDs that are specific to respective items of tracking information. The column 424 stores a list of frame IDs for respective frames for which the element represented by the node appears within the video. These items of information are stored in each row for each item of tracking information, whereby the tracking information table 42 is configured.

As illustrated in FIG. 5(c), the frame information table 43 is represented by a data table that includes columns 431 through 434, for example. The column 431 stores a series of reference numbers that are set with respect to respective rows in the data table. The column 432 stores track IDs for items of tracking information to which respective items of frame information belongs. A value for this track ID is associated with a value for a track ID stored in the column 423 in the data table in FIG. 5(b) and, as a result, respective items of frame information and tracking information are associated. The column 433 stores frame IDs that are specific to respective items of frame information. The column 434 stores information representing the position of each element within the frame represented by the frame information and the type (such as person or object) of each element. These items of information are stored in each row for each item of frame information, whereby the frame information table 43 is configured.

FIG. 6 is a view that illustrates an example of a data structure of the edge database 50. As illustrated in FIG. 6, the edge database 50 is represented as a data table that includes columns 501 through 506, for example. The column 501 stores a series of reference numbers that are set with respect to respective rows in the data table. The column 502 stores a graph ID for graph data to which each edge belongs. A value for this graph ID is associated with a value for a graph ID stored in the column 302 in the data table in FIG. 4 and, as a result, respective edges and graph data are associated. The columns 503 and 504 respectively store node IDs for nodes that are positioned at the start point and end point of each edge. Values for these node IDs are respectively associated with values for node IDs stored in the column 413 in the data table in FIG. 5(a) and, as a result, between which nodes each edge represents relatedness for is identified. The column 505 stores edge IDs that are specific to respective edges. The column 506 stores, as edge information representing the relatedness between elements that the edge represents, details of an action that a person corresponding to the start node performs with respect to another person or an object corresponding to the end node. These items of information are stored in each row for each edge, whereby the edge database 50 is configured.

FIG. 7 is a view for describing the graph data visualization editing unit 60. The graph data visualization editing unit 60 presents a graph data editing screen 61 which is illustrated in FIG. 7, for example, to a user by displaying the graph data edit screen 61 on an unillustrated display. In this graph data editing screen 61, a user can perform a predetermined operation to thereby optionally edit graph data. For example, in the graph data editing screen 61, graph data 610 generated by the graph data generation unit 20 is visualized and displayed. In this graph data 610, a user can select any node or edge on the screen to thereby cause the display of a node information box 611 or 612 that indicates detailed information for a node or an edge information box 613 that illustrates detailed information for an edge. These information boxes 611 through 613 display attribute information for respective nodes. A user can select any attribute information within the information boxes 611 through 613 to thereby edit details of respective items of attribute information indicated by underlining.

The graph data editing screen 61 displays an add node button 614 and an add edge button 615 in addition to the graph data 610. A user can select the add node button 614 or the add edge button 615 on the screen to thereby add a node or an edge to any position with respect to the graph data 610. Furthermore, it is possible to select any node or edge in the graph data 610 and perform a predetermined operation (for example, a mouse drag or a right-click) to thereby move or delete the node or edge.

The graph data visualization editing unit 60 can edit, as appropriate, details of generated graph data in accordance with a user operation as described above. Edited graph data is then reflected to thereby update the graph database 30.

FIG. 8 is a block view that illustrates a configuration of the node feature vector extraction unit 70. As illustrated in FIG. 7, the node feature vector extraction unit 70 is configured by being provided with a maximum entropy frame sampling processing unit 71, a person/object region image obtainment unit 72, an image feature vector calculation unit 73, an attribute information obtainment unit 74, an attribute information feature vector calculation unit 75, a feature vector combining processing unit 76, an attribute weight calculation attention mechanism 77, and a node feature vector calculation unit 78.

The maximum entropy frame sampling processing unit 71 reads out node data for each node from the node database 40 and, for each node, samples a frame having the maximum entropy from within the video.

From the frame sampled by the maximum entropy frame sampling processing unit 71, the person/object region image obtainment unit 72 obtains region images for people or objects corresponding to elements represented by respective nodes.

From the region images for respective people or respective objects obtained by the person/object region image obtainment unit 72, the image feature vector calculation unit 73 calculates an image feature vector for each element represented by each node. Here, for example, a DNN (Deep Neural Network) for object classification that is trained in advance using a large-scale image dataset (for example, MS COCO or the like) is used, and an output from an intermediate layer when a region image for each element is inputted to this DNN is extracted, whereby an image feature vector is calculated. Note that another method may be used if it is possible to calculate an image feature vector with respect to a region image for each element.

The attribute information obtainment unit 74 reads out node information for each node from the node database 40, and obtains attribute information for each node.

From the attribute information obtained by the attribute information obtainment unit 74, the attribute information feature vector calculation unit 75 calculates a feature vector for the attribute information for each element that is represented by a respective node. Here, for example, a predetermined language processing algorithm (for example, word2Vec or the like) is used on text data configuring the attribute information, whereby a feature vector is calculated for each attribute item (such as gender, age, clothing, whether wearing a mask or not, size, color, or stay time) for each element, the attribute items being represented by the attribute information. Note that another method may be used if it is possible to calculate an attribute information feature vector with respect to attribute information for each element.

The feature vector combining processing unit 76 performs a combining process for combining an image feature vector calculated by the image feature vector calculation unit 73 with an attribute information feature vector calculated by the attribute information feature vector calculation unit 75. Here, for example, a feature vector with respect to a feature for the entirety of the person or object represented by the image feature vector and a feature vector for each attribute item of the person or object represented by the attribute information are employed as vector components, and a combined feature vector that corresponds to feature vectors for these items is created for each element.

With respect to the feature vector resulting from the combining by the feature vector combining processing unit 76, the attribute weight calculation attention mechanism 77 obtains a weight for each item in the feature vector. Here, respective weights learned in advance are obtained for each vector component of the combined feature vector, for example. Information regarding a weight obtained by the attribute weight calculation attention mechanism 77 is stored in the element contribution level saving unit 160 as an element contribution level representing a contribution level for each node feature vector item with respect to the threat indication level calculated by the anomaly detection unit 130.

The node feature vector calculation unit 78 multiplies the feature vector resulting from the combining by the feature vector combining processing unit 76 by the weights obtained by the attribute weight calculation attention mechanism 77 to thereby perform a weighting process and calculate a node feature vector. In other words, values resulting from multiplying respective vector components in the combined feature vector by weights set by the attribute weight calculation attention mechanism 77 are summed together to thereby calculate the node feature vector.

By processing by each block described above, for each item of graph data generated for each time range set at intervals of the time section At, a node feature vector representing an attribute feature vector is extracted for each element by the node feature vector extraction unit 70. Information regarding an extracted node feature vector is stored in the node feature vector accumulation unit 90.

FIG. 9 is a view that illustrates an outline of processing performed by the node feature vector extraction unit 70. As illustrated in FIG. 9, the node feature vector extraction unit 70 uses the image feature vector calculation unit 73 to calculate an image feature vector with respect to a frame having the maximum entropy for the person 2 within a video corresponding to a respective item of graph data while also using the attribute information feature vector calculation unit 75 to calculate a feature vector for each attribute item in attribute information for the node P1 corresponding to the person 2, whereby a node P1 feature vector for each item such as “whole-body feature vector,” “mask,” “skin color,” or “stay time” is obtained. The node feature vector calculation unit 78 uses weights obtained by the attribute weight calculation attention mechanism 77 to perform a weighting computation with respect to each of these items and thereby extract a feature vector for the node P1. A similar calculation is performed for each of the other nodes, whereby a feature vector is obtained for each node in the graph data. Note that the weights obtained by the attribute weight calculation attention mechanism 77 are stored as element contribution levels in the element contribution level saving unit 160.

FIG. 10 is a block view that illustrates a configuration of the edge feature vector extraction unit 80. As illustrated in FIG. 10, the edge feature vector extraction unit 80 is configured by being provided with an edge information obtainment unit 81, an edge feature vector calculation unit 82, an edge weight calculation attention mechanism 83, and a weighting calculation unit 84.

The edge information obtainment unit 81 reads out and obtains edge information for each edge from the edge database 50.

From the edge information obtained by the edge information obtainment unit 81, the edge feature vector calculation unit 82 calculates an edge feature vector which is a feature vector regarding the relatedness between elements represented by each edge. Here, for example, the edge feature vector is calculated by using a predetermined language processing algorithm (for example, word2Vec or the like) on text data such as “handover” or “conversation” representing action details set as edge information.

The edge weight calculation attention mechanism 83 obtains a weight for the edge feature vector calculated by the edge feature vector calculation unit 82. Here, for example, a weight learned in advance is obtained for the edge feature vector. Information regarding a weight obtained by the edge weight calculation attention mechanism 83 is stored in the element contribution level saving unit 160 as an element contribution level representing a contribution level for the edge feature vector with respect to the threat indication level calculated by the anomaly detection unit 130.

The weighting calculation unit 84 multiplies the edge feature vector calculated by the edge feature vector calculation unit 82 by the weight obtained by the edge weight calculation attention mechanism 83 to thereby perform a weighting process and calculate a weighted edge feature vector.

By processing by each block described above, for each item of graph data generated for each time range set at intervals of the time section At, an edge feature vector representing a feature vector for relatedness between elements is extracted by the edge feature vector extraction unit 80. Information regarding an extracted edge feature vector is stored in the edge feature vector accumulation unit 100.

FIG. 11 is a block view that illustrates a configuration of the spatiotemporal feature vector calculation unit 110. As illustrated in FIG. 11, the spatiotemporal feature vector calculation unit 110 is configured by being provided with a plurality of residual convolution computation blocks 111 and a node feature vector updating unit 112. The residual convolution computation blocks 111 individually correspond to a predetermined number of stages, each execute a convolution computation after receiving a computation result from a preceding-stage residual convolution computation block 111, and perform an input to a subsequent-stage residual convolution computation block 111. Note that the residual convolution computation block 111 at the first stage is inputted with a node feature vector and an edge feature vector respectively read from the node feature vector accumulation unit 90 and the edge feature vector accumulation unit 100, and a computation result from the residual convolution computation block 111 at the final stage is inputted to the node feature vector updating unit 112. As a result, calculation of a spatiotemporal feature vector using a GNN (Graph Neural Network) is realized.

The spatiotemporal feature vector calculation unit 110 performs convolution processing as described above in each of the plurality of residual convolution computation blocks 111. In order to realize this convolution processing, each residual convolution computation block 111 is configured by being provided with two space convolution computation processing units 1110 and one time convolution computation processing unit 1111.

Each space convolution computation processing unit 1110 calculates, as a space-direction convolution computation, an outer product of feature vectors for adjacent nodes that are adjacent to respective nodes in the graph data and feature vectors for edges set between the respective nodes and the adjacent nodes, and then performs a weighting computation using a D×D-sized weight matrix on this outer product. Here, the value of the number of dimensions D for the weight matrix is defined as the length of the feature vector for each node. As a result, a weighted linear transformation that can be learned is used to guarantee the diversity of learning. In addition, because it is possible to design the weight matrix without suffering constraints due to the number of nodes and edges included in graph data, it is possible to use an optimal weight matrix to perform a weighting computation.

The residual convolution computation block 111 performs a weighting computation in accordance with a space convolution computation processing unit 1110 twice with respect to each node included in graph data. As a result, the space-direction convolution computation is realized.

The time convolution computation processing unit 1111 performs a time-direction convolution computation with respect to the feature vector for each node for which the space-direction convolution computation has been performed by the two space convolution computation processing units 1110. Here, an outer product is calculated between feature vectors for nodes adjacent to respective nodes in the time direction, in other words, nodes representing the same person or object as that for a corresponding node in graph data generated with respect to a video in an adjacent time range, and feature vectors for edges set for the adjacent nodes, and a weighting computation similar to that in a space convolution computation processing unit 1110 is performed on this outer product. As a result, the time-direction convolution computation is realized.

The spatiotemporal feature vector calculated using the space-direction and time-direction convolution computations described above and the node feature vector inputted to the residual convolution computation block 111 are added together, whereby a result of computation by the residual convolution computation block 111 is obtained. By performing such computations, it is possible to have convolution processing that simultaneously adds, to the feature vectors for respective nodes, feature vectors for adjacent nodes that are adjacent in each of the space direction and the time direction as well as edges between adjacent nodes.

The node feature vector updating unit 112 uses the computation result outputted from the residual convolution computation block 111 at the final stage to update the feature vectors of respective nodes accumulated in the node feature vector accumulation unit 90. As a result, the spatiotemporal feature vector calculated for each node included in the graph data is reflected to the feature vector for each node.

In accordance with processing by each block described above, the spatiotemporal feature vector calculation unit 110 can use a GNN to calculate a spatiotemporal feature vector for each item of graph data, and reflect the spatiotemporal feature vector to the node feature vector to thereby update the node feature vector. Note that, in training of the GNN in the spatiotemporal feature vector calculation unit 110, it is desirable to train a residual function that refers to an input for any layer, whereby it is possible to prevent gradient explosion or vanishing gradient problems even if the layer for a time of training is deep. Accordingly, it is possible to calculate a node feature vector that reflects more accurate spatiotemporal information.

FIG. 12 is a view that illustrates an example of an equation that represents a computation process in a space convolution computation processing unit 1110. For example, the space convolution computation processing unit 1110 calculates each matrix operation expression as illustrated in FIG. 12 to thereby perform a space convolution computation. Pooling (concatenation or average) is performed on an obtained N×D×P (N is the number of nodes, D is the length of a node feature vector, and P is the number of channels for a matrix operation=the length of an edge feature vector) tensor, and this is repeatedly performed for the number of residual convolution computation blocks 111 provided according to the number of layers in the GNN, whereby a feature vector resulting from a space convolution is calculated, a time convolution computation is also performed, and a spatiotemporal feature vector is calculated and reflected to the node feature vector.

Here, a convolution computation performed by a space convolution computation processing unit 1110 and a convolution computation performed by the time convolution computation processing unit 1111 are respectively represented by equations (1) and (2) below.

$$\begin{matrix}[ Equation 1 ] & \\ {H}_{t}^{l} = φ [ {{O}_{p = 0}}^{P} ( {E}_{.. p} {H}_{t}^{l - 1} {W}_{S}^{l} ) ] & ( 1 )\end{matrix}$$

$$\begin{matrix}[ Equation 2 ] & \\ {M}_{i}^{k} = φ [ ( ( F ∘ Q ) {M}_{i}^{k - 1} {W}_{T}^{k} ) ] & ( 2 )\end{matrix}$$

In equation (1), O represents pooling (concatenation or average), φ represents a nonlinear activation function, and l represents a GNN layer number to which the space convolution computation processing unit 1110 corresponds. In addition, in equation (2), k represents a GNN layer number to which the time convolution computation processing unit 1111 corresponds.

In addition, in FIG. 12 and equations (1) and (2), H^{N×D} represents a space node feature vector matrix, N represents the number of nodes within the graph data, and D represents the length (number of dimensions) of the node feature vector. Mᵢ^{L×D} represents a time node feature vector matrix for the i-th node, and L represents the length of time. E^{N×N×P} represents an edge feature vector matrix, and Eᵢⱼ represents a feature vector (number of dimensions P) for an edge that joins the i-th node with the j-th node. Here, Eᵢⱼ=0 in a case where an edge joining the i-th node to the j-th node is not present.

In addition, in FIG. 12 and equations (1) and (2), Fᵢ^{1×D} represents a time node feature vector matrix for the i-th node. Fᵢⱼ represents the presence or absence of the j-th node in the j-th item of graph data. Here, Fᵢⱼ=0 in a case where the j-th node is not present in the j-th item of graph data, and Fᵢⱼ=1 in a case of being present.

Furthermore, in FIG. 12 and equations (1) and (2), represents a convolution kernel for weighting relatedness between nodes in the time direction, W_{S}^{l} represents a D×D-sized weighting matrix pertaining to node feature vectors in the space direction, and W_{T}^{k} represents a D×D-sized weighting matrix pertaining to node feature vectors in the time direction.

FIG. 13 is a view that illustrates an outline of processing performed by the spatiotemporal feature vector calculation unit 110. In FIG. 13, dotted lines represent space convolution computations by the space convolution computation processing units 1110, and broken lines represent time convolution computations by the time convolution computation processing units 1111. As illustrated in FIG. 13, for example, with respect to a node 3 in a t-th item of graph data, a space feature vector that corresponds to feature vectors for adjacent nodes 1 and 4 and feature vectors for edges set between the node 3 and these adjacent nodes is added in accordance with a space convolution computation. In addition, a time feature vector that corresponds to the feature vector for the node 3 in the t−1-th item of graph data immediately prior and the feature vector for the node 3 in the t+1-th item of graph data immediately after is added in accordance with a time convolution computation. As a result, a spatiotemporal feature vector for the t-th item of graph data with respect to the node 3 is calculated and reflected to the feature vector for the node 3.

FIG. 14 is a block view that illustrates a configuration of the anomaly detection unit 130. As illustrated in FIG. 14, the anomaly detection unit 130 is configured by being provided with a feature vector distribution clustering unit 131, a center point distance calculation unit 132, and an anomaly determination unit 133.

The feature vector distribution clustering unit 131 performs a clustering process on feature vectors that are for respective nodes and are obtained from the node feature vector accumulation unit 90 by the node feature vector obtainment unit 120, and obtains a distribution for the node feature vectors. Here, for example, the feature vectors for respective nodes are each plotted on a two-dimensional map to thereby obtain a node feature vector distribution.

The center point distance calculation unit 132 calculates a distance from the center point for the node feature vectors in the node feature vector distribution obtained by the feature vector distribution clustering unit 131. As a result, node feature vectors, to which the spatiotemporal feature vectors have been reflected, are mutually compared. The distance, which is from the center point for the node feature vectors and is calculated by the center point distance calculation unit 132, is stored in the threat indication level saving unit 140 as a threat indication level that indicates a level of a threat for the elements corresponding to the respective nodes.

The anomaly determination unit 133 determines the threat indication level for each node on the basis of the distance calculated by the center point distance calculation unit 132. As a result, in a case where there is a node for which the threat indication level is greater than or equal to a predetermined value, the element corresponding to this node is determined to be a suspicious person or a suspicious item, an anomaly in the location to be monitored is detected, and a notification to a user is made. The notification to the user is performed using an alarm apparatus that is not illustrated, for example. At this time, the position of an element determined to be a suspicious person or a suspicious item may be subjected to an emphasized display in the video from the surveillance camera. An anomaly detection result by the anomaly determination unit 133 is stored in the threat indication level saving unit 140 in association with the threat indication level.

In accordance with processing by each block described above, the anomaly detection unit 130, on the basis of the spatiotemporal feature vectors calculated by the spatiotemporal feature vector calculation unit 110, can detect an anomaly in the location to be monitored while also comparing spatiotemporal feature vectors for each element with each other and obtaining a threat indication level for each element on the basis of a result of this comparing.

FIG. 15 is a view that illustrates an outline of processing performed by the anomaly detection unit 130. As illustrated in FIG. 15, for each node in graph data that includes nodes P3, P6, and 02, the anomaly detection unit 130 plots, on a two-dimensional map, each node feature vector for which a spatiotemporal feature vector has been determined to thereby obtain a node feature vector distribution. A center point for the obtained node feature vector distribution is obtained, and the distance from this center point to each node feature vector is calculated to thereby obtain a threat indication level for each node. As a result, an element corresponding to a node for which the threat indication level is greater than or equal to the predetermined value, for example, a person corresponding to the node P6 for which the node feature vector is outside of a distribution circle 4 on a distribution diagram, is determined to be a suspicious person or a suspicious item, and an anomaly is detected.

FIG. 16 is a block view that illustrates a configuration of the determination ground presentation unit 150. As illustrated in FIG. 16, the determination ground presentation unit 150 is configured by being provided with a ground confirmation target selection unit 151, a subgraph extraction processing unit 152, a person attribute threat contribution level presentation unit 153, an object attribute threat contribution level presentation unit 154, an action history contribution level presentation unit 155, and a verbalized summary generation unit 156.

The ground confirmation target selection unit 151 obtains threat indication levels that are stored in the threat indication level saving unit 140 and, on the basis of the obtained threat indication level for each node, selects, as an anomaly detection ground confirmation target, one portion of graph data that includes the node for which an anomaly has been detected by the anomaly detection unit 130. Here, for example, a portion related to a node having the highest threat indication level may be automatically selected, or it may be that, in response to a user operation, a freely-defined node is designated and a portion relating to this node is selected.

The subgraph extraction processing unit 152 obtains graph data stored in the graph database 30, and extracts, as a subgraph that indicates the anomaly detection ground confirmation target, the portion selected by the ground confirmation target selection unit 151 in the obtained graph data. For example, a node having the highest threat indication level or a node designated by a user as well as each node and each edge connected to this node are extracted as a subgraph.

In a case where a node included in the subgraph extracted by the subgraph extraction processing unit 152 represents a person, the person attribute threat contribution level presentation unit 153 calculates contribution levels with respect to the threat indication level due to attributes held by this person, visualizes the contribution levels, and presents the contribution levels to the user. For example, regarding various attribute items (such as gender, age, clothing, whether wearing a mask or not, or stay time) represented by attribute information included in node information for this node, the contribution level for each attribute item is calculated on the basis of the element contribution level saved in the element contribution level saving unit 160, in other words, the weight for each attribute item with respect to the node feature vector. A predetermined number of attribute items are selected in order from those for which the calculated contribution level is high, and details and contribution levels for the respective attribute items are presented in a predetermined layout on the anomaly detection screen.

In a case where a node included in the subgraph extracted by the subgraph extraction processing unit 152 represents an object, the object attribute threat contribution level presentation unit 154 calculates contribution levels with respect to the threat indication level due to attributes held by this object, visualizes the contribution levels, and presents the contribution levels to the user. For example, regarding various attribute items (such as size, color, or stay time) represented by attribute information included in node information for this node, the contribution level for each attribute item is calculated on the basis of the element contribution level saved in the element contribution level saving unit 160, in other words, the weight for each attribute item with respect to the node feature vector. A predetermined number of attribute items are selected in order from those for which the calculated contribution level is high, and details and contribution levels for the respective attribute items are presented in a predetermined layout on the anomaly detection screen.

In a case where a node included in the subgraph extracted by the subgraph extraction processing unit 152 represents a person or an object, the action history contribution level presentation unit 155 calculates contribution levels with respect to the threat indication level due to an action performed between this person or object and another person or object, visualizes the contribution levels, and presents the contribution levels to the user. For example, for each edge connected to this node, the contribution level for each edge is calculated on the basis of the element contribution level saved in the element contribution level saving unit 160, in other words, the weight with respect to the edge feature vector. A predetermined number of edges are selected in order from those for which the calculated contribution level is high, and contribution levels as well as action details represented by the respective edges are presented in a predetermined layout on the anomaly detection screen.

The verbalized summary generation unit 156 verbalizes respective details presented by the person attribute threat contribution level presentation unit 153, the object attribute threat contribution level presentation unit 154, and the action history contribution level presentation unit 155 to thereby generate a text (summary) that concisely represents the anomaly detection ground. The generated summary is displayed at a predetermined position within the anomaly detection screen.

Regarding elements such as a person or object for which an anomaly is detected by the anomaly detection unit 130, the determination ground presentation unit 150 can, in accordance with processing by each block described above, present to a user, as a screen that indicates a ground for a determination by the anomaly detection unit 130, an anomaly detection screen that includes at least the threat indication level calculated for the element and information regarding a feature or action for the element for which a contribution level to the threat indication level is high.

FIG. 17 depicts views that illustrate an outline of processing performed by the ground confirmation target selection unit 151 and the subgraph extraction processing unit 152. FIG. 17(a) illustrates an example in which graph data is visualized before subgraph extraction, and FIG. 17(b) illustrates an example in which graph data is visualized after subgraph extraction.

When a user uses a predetermined operation (such as a mouse click, for example) to designate any node in the graph data illustrated in FIG. 17(a), the ground confirmation target selection unit 151 selects, as an anomaly detection ground confirmation target, the designated node and each node and each edge connected to this node. At this point, the subgraph extraction processing unit 152 extracts, as a subgraph, the nodes and edges selected by the ground confirmation target selection unit 151, and subjects the extracted subgraph to an emphasized display while also displaying as grayed-out a portion other than the subgraph in the graph data to thereby visualize the subgraph.

For example, a case in which a user has designated a node O2 in the graph data in FIG. 17(a) is considered. In this case, a portion that includes the designated node O2, the nodes P2 and P4 which are adjacent to the node O2, and respective edges set between the nodes O2, P2, and P4 is selected by the ground confirmation target selection unit 151, and extracted as a subgraph by the subgraph extraction processing unit 152. As illustrated in FIG. 17(b), these nodes and edges that have been extracted are each subjected to an emphasized display and the remaining portion is displayed as grayed-out, whereby the subgraph is visualized.

FIG. 18 is a view that illustrates an example of the anomaly detection screen displayed by the determination ground presentation unit 150. In an anomaly detection screen 180 illustrated in FIG. 18, for each person and object for which an anomaly has been detected, the threat indication level thereof is indicated as a threat level, and a contribution level is indicated for each feature or action with respect to the threat indication level. Specifically, contribution levels with respect to the items “mask,” “stay time,” and “upper body color” are indicated for a person captured by a camera 2, and contribution levels with respect to the items “abandoned,” “stay time,” and “handover” are indicated for an object captured by a camera 1. In addition, a summary generated by the verbalized summary generation unit 156 is displayed as suspicious points pertaining to this person or object. Furthermore, a video indicating a suspicious action taken by the person and an image capturing time therefor are displayed as an action timeline.

Note that the anomaly detection screen 180 illustrated in FIG. 18 is an example, and any anomaly detection screen having different contents or screen layout may be displayed if it is possible to present an anomaly detection result by the anomaly detection unit 130 and grounds therefor in a manner that is easy for a user to understand.

In the present embodiment, description has been given for an example of application to the anomaly detection system 1 which detects an anomaly at a location to be monitored, but it is possible to have application to an apparatus that is inputted with video data or image data and performs similar processing on this input data to thereby perform data analysis. In other words, the anomaly detection system 1 according to the present embodiment may be reworded as a data analysis apparatus 1.

By virtue of the first embodiment of the present invention as described above, the following effects are achieved.

(1) The data analysis apparatus 1 is provided with: the graph data generation unit 20 that generates, in chronological order, a plurality of items of graph data configured by combining a plurality of nodes representing attributes for each element and a plurality of edges representing relatedness between the plurality of nodes; the node feature vector extraction unit 70 that extracts a node feature vector for each of the plurality of nodes; the edge feature vector extraction unit 80 that extracts an edge feature vector for each of the plurality of edges; and the spatiotemporal feature vector calculation unit 110 that calculates a spatiotemporal feature vector indicating a change in node feature vector by performing, on the plurality of items of graph data generated by the graph data generation unit 20, convolution processing for each of a space direction and a time direction, on the basis of the node feature vector and the edge feature vector. Thus, in a case where the structure of graph data dynamically changes in the time direction, it is possible to effectively obtain a change in node feature vector which corresponds thereto.

(2) A node in graph data represents attributes of a person or object appearing in a video or image obtained by capturing a predetermined location to be monitored, and an edge in graph data represents an action that a person performs with respect to another person or an object. Thus, it is possible to appropriately represent, in graph data, features of a person or object appearing in the video or image.

(3) The data analysis apparatus 1 is also provided with the anomaly detection unit 130 that detects an anomaly in the location to be monitored, on the basis of a spatiotemporal feature vector calculated by the spatiotemporal feature vector calculation unit 110. Thus, from a video or image resulting from capturing various people or objects, it is possible to accurately discover a suspicious action or an anomalous action at a location to be monitored and thereby detect an anomaly.

(4) A computer that configures the data analysis apparatus 1 executes: a process for generating, in chronological order, a plurality of items of graph data configured by combining a plurality of nodes representing attributes for each element and a plurality of edges representing relatedness between the plurality of nodes (processing by the graph data generation unit 20); a process for extracting a node feature vector for each of the plurality of nodes (processing by the node feature vector extraction unit 70); a process for extracting an edge feature vector for each of the plurality of edges (processing by the edge feature vector extraction unit 80); and a process for calculating a spatiotemporal feature vector indicating a change in node feature vector by performing, on the plurality of items of graph data, convolution processing for each of a space direction and a time direction, on the basis of the node feature vector and the edge feature vector (processing by the spatiotemporal feature vector calculation unit 110). Thus, in accordance with processing using the computer, in a case where the structure of graph data dynamically changes in the time direction, it is possible to effectively obtain a change in node feature vector which corresponds thereto.

### Second Embodiment

Next, description is given regarding a second embodiment of the present invention.

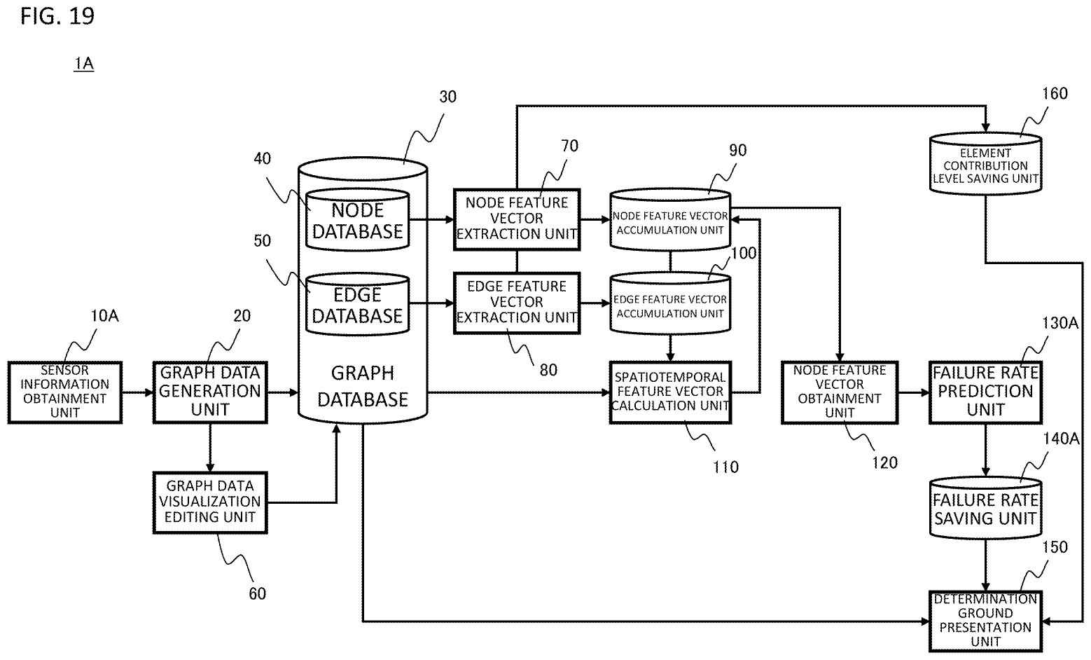

FIG. 19 is a block view that illustrates a configuration of a sensor failure estimation system according to the second embodiment of the present invention. A sensor failure estimation system 1A according to the present embodiment monitors each of a plurality of sensors installed at respective predetermined locations, and estimates whether a failure has occurred in each sensor. A difference between the sensor failure estimation system 1A illustrated in FIG. 19 and the anomaly detection system 1 described in the first embodiment is that the sensor failure estimation system 1A is provided with a sensor information obtainment unit 10A, a failure rate prediction unit 130A, and a failure rate saving unit 140A in place of the camera moving image input unit 10, the anomaly detection unit 130, and the threat indication level saving unit 140 in FIG. 1. Description is given below regarding the sensor failure estimation system 1A according to the present embodiment, centered on differences from the anomaly detection system 1.

The sensor information obtainment unit 10A is connected by wire or wirelessly to an unillustrated sensor system, obtains data for an amount of operating time or sensed information from each sensor included in the sensor system, and inputs the data to the graph data generation unit 20. In addition, communication is mutually performed between respective sensors in the sensor system. The sensor information obtainment unit 10A obtains a communication speed for between sensors, and inputs the communication speed to the graph data generation unit 20.

In the present embodiment, on the basis of each above item of information inputted from the sensor information obtainment unit 10A, the graph data generation unit 20 generates graph data that combines a plurality of nodes representing attributes of each sensor in the sensor system and a plurality of edges representing relatedness between respective sensors. Specifically, with respect to input information, the graph data generation unit 20 performs sensor attribute estimation using an attribute estimation model trained in advance to thereby extract information regarding each node in the graph data, and stores the information in the node database 40. For example, sensed information such as a temperature, vibration, or humidity sensed by each sensor, an amount of operating time for each sensor, or the like is estimated as attributes for each sensor. In addition, the graph data generation unit 20 obtains communication speeds between respective sensors from the input information to thereby extract information for each edge in the graph data, and stores this information in the edge database 50. As a result, graph data representing features of the sensor system is generated and stored in the graph database 30.

The failure rate prediction unit 130A predicts a failure rate for each sensor in the sensor system on the basis of a node feature vector inputted from the node feature vector obtainment unit 120. Here, as described above, the spatiotemporal feature vector calculated by the spatiotemporal feature vector calculation unit 110 has been reflected to a node feature vector inputted from the node feature vector obtainment unit 120. In other words, the failure rate prediction unit 130A calculates the failure rate for each sensor on the basis of the spatiotemporal feature vector calculated by the spatiotemporal feature vector calculation unit 110 to thereby monitor the sensor system. The failure rate prediction unit 130A stores a prediction result for the failure rate for each sensor in the failure rate saving unit 140A.

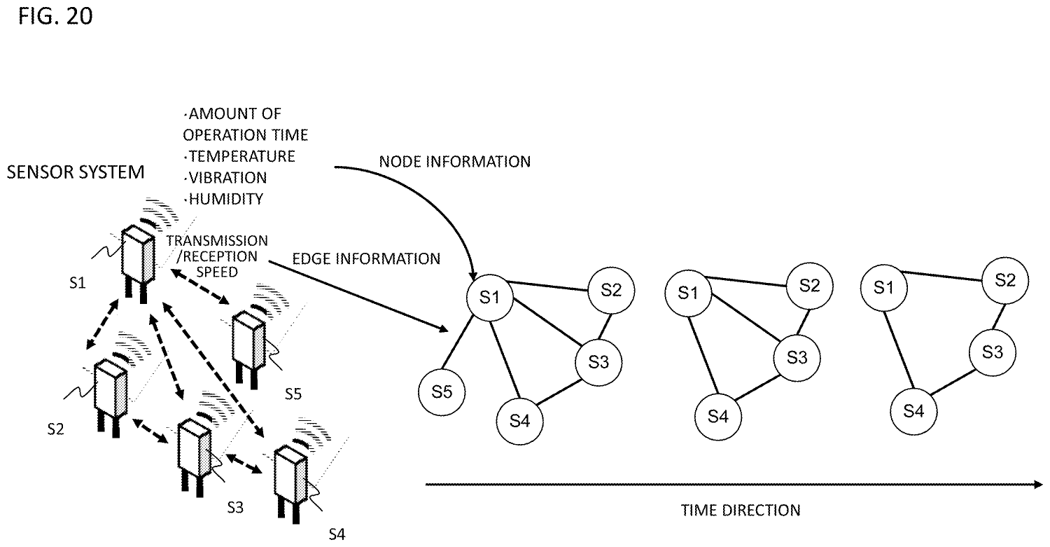

FIG. 20 is a view that illustrates an outline of processing performed by the graph data generation unit 20 in the sensor failure estimation system 1A according to the second embodiment of the present invention. As illustrated in FIG. 20, the graph data generation unit 20 obtains, as node information, information such as the amount of operating time for each sensor and information such as a temperature, vibration, or humidity detected by each sensor, from each of sensors S1 through S5 in the sensor system. In addition, communication is individually performed between the sensor S1 and the sensors S2 through S5, between the sensor S2 and the sensor S3, and between the sensor S3 and the sensor S4. The graph data generation unit 20 obtains, as edge information, a transmission/reception speed for communication between these respective sensors. On the basis of these obtained items of information, graph data that includes a plurality of nodes and edges is generated every certain time section At. In this graph data, for example, the sensors S1 through S5 are respectively represented as nodes S1 through S5, and attribute information for each sensor represented by obtained node information is set with respect to these nodes S1 through S5. In addition, edges having edge information corresponding to respective communication speeds are set between the node S1 and the nodes S2 through S5, between the node S2 and the node S3, and between the node S3 and the node S4. Information regarding graph data generated in this manner is stored in the graph database 30.

Failure estimation for a sensor is concerned with transition of sensor status historical data that has been accumulated up until the estimation time. For a graph representing sensor operating states that has been constructed by the above method, it is possible for a note or an edge to be missing due to a sensor failure or poor communication in the time direction. Accordingly, it is possible for the structure of the graph in the time direction to dynamically change, and a method of analyzing dynamic graph data is required. Accordingly, in a case where the structure of graph data dynamically changes in the time direction, means for effectively obtaining a change in node feature vector which corresponds thereto is required, and application of the present invention is desirable.

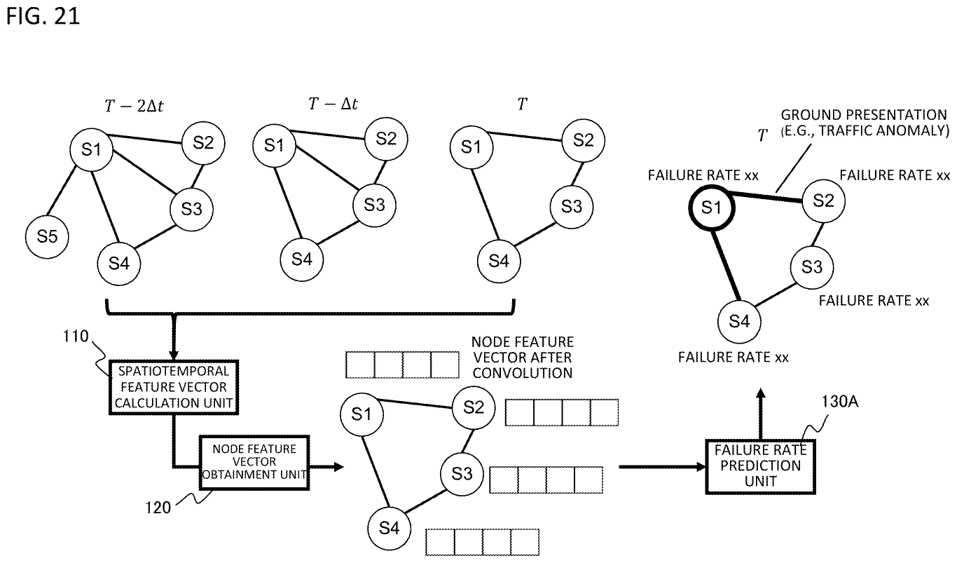

FIG. 21 is a view that illustrates an outline of processing performed by the spatiotemporal feature vector calculation unit 110 and the failure rate prediction unit 130A in the sensor failure estimation system 1A according to the second embodiment of the present invention. As illustrated in FIG. 21, on the basis of a node feature vector and an edge feature vector individually extracted from graph data generated every certain time section At, the spatiotemporal feature vector calculation unit 110 performs a convolution computation in each of the space direction and the time direction on the nodes S1 through S4 to thereby reflect the spatiotemporal feature vector to a feature vector for each node. The feature vector which is for each node and to which the spatiotemporal feature vector has been reflected is obtained by the node feature vector obtainment unit 120 and inputted to the failure rate prediction unit 130A. On the basis of the feature vector for each node inputted from the node feature vector obtainment unit 120, the failure rate prediction unit 130A, for example, performs regression analysis or obtains a reliability for a binary classification result that corresponds to the presence or absence of a failure, to thereby calculate a prediction value for the failure rate for each sensor.

The failure rate calculated by the failure rate prediction unit 130A is stored in the failure rate saving unit 140A while also being presented to a user in a predetermined form by the determination ground presentation unit 150. Furthermore, at this point, as illustrated in FIG. 21, it may be that a node for which the failure rate is greater than or equal to a predetermined value and an edge connected to this node are subjected to an emphasized display, and an estimated cause (for example, a traffic anomaly) is presented as a determination ground.

In the present embodiment, description has been given for an example of application to the sensor failure estimation system 1A that estimates the presence or absence of occurrence of a failure for each sensor in a sensor system, but it is possible to have application to an apparatus that is inputted with information regarding each sensor and performs similar processing on these items of input data to thereby perform data analysis. In other words, the sensor failure estimation system 1A according to the present embodiment may be reworded as a data analysis apparatus 1A.

By virtue of the second embodiment of the present invention described above, a node in graph data represents attributes of a sensor installed at a predetermined location, and an edge in the graph data represents the speed of communication that the sensor performs with another sensor. Thus, it is possible to appropriately represent, in graph data, features of a sensor system configured by a plurality of sensors.

In addition, by virtue of the second embodiment of the present invention, the data analysis apparatus 1A is provided with the failure rate prediction unit 130A that predicts a failure rate for a sensor on the basis of a spatiotemporal feature vector calculated by the spatiotemporal feature vector calculation unit 110. Thus, in a case where it is predicted that a failure has occurred in the sensor system, it is possible to reliably discover this.

### Third Embodiment

Next, description is given regarding a third embodiment of the present invention.

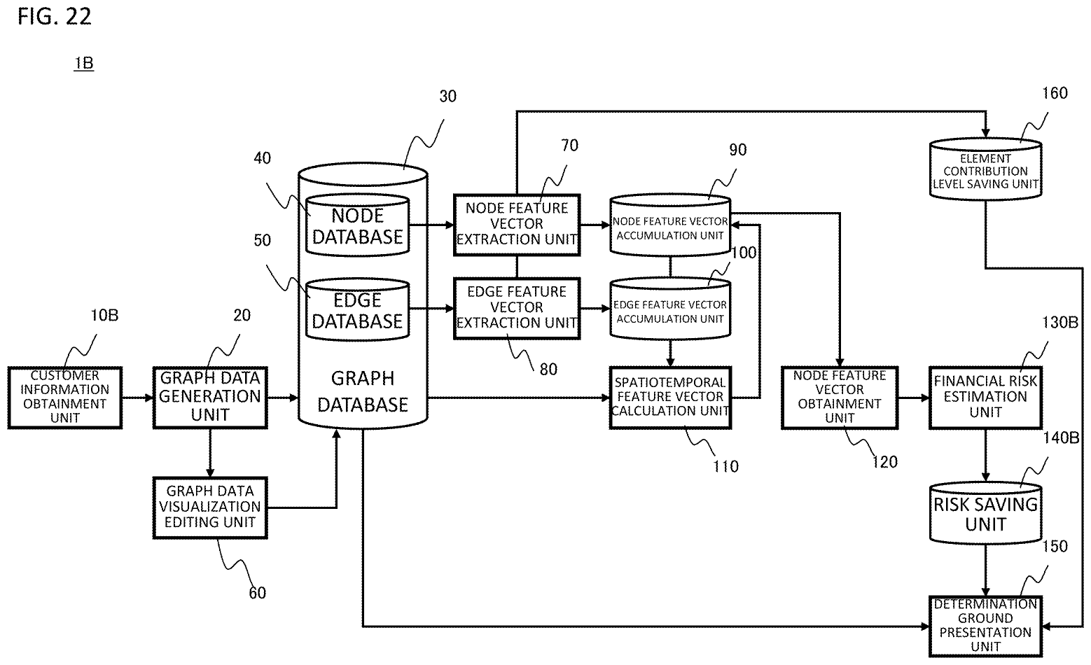

FIG. 22 is a block view that illustrates a configuration of a financial risk management system according to the third embodiment of the present invention. For a customer who uses a credit card or a loan, a financial risk management system 1B according to the present embodiment estimates a financial risk (credit risk), which is a monetary risk regarding this customer. A difference between the financial risk management system 1B illustrated in FIG. 22 and the anomaly detection system 1 described in the first embodiment is that the financial risk management system 1B is provided with a customer information obtainment unit 10B, a financial risk estimation unit 130B, and a risk saving unit 140B in place of the camera moving image input unit 10, the anomaly detection unit 130, and the threat indication level saving unit 140 in FIG. 1. Description is given below regarding the financial risk management system 1B according to the present embodiment, centered on differences from the anomaly detection system 1.

The customer information obtainment unit 10B obtains attribute information for each customer who uses a credit card or a loan, an organization (such as a workplace) to which each customer is affiliated with, and information pertaining to relatedness (such as family or friends) between each customer and a related person therefor, and inputs this information to the graph data generation unit 20. In addition, information regarding, inter alia, a type of a product purchased by each customer or a facility (sales outlet) pertaining to the product is also obtained and inputted to the graph data generation unit 20.

In the present embodiment, on the basis of each abovementioned item of information inputted from the customer information obtainment unit 10B, the graph data generation unit 20 generates graph data that combines a plurality of nodes representing attributes for, inter alia, customers, products, and organizations, and a plurality of edges representing relatedness between these. Specifically, the graph data generation unit 20 obtains, from input information, information such as attributes (such as age, income, and debt ratio) of each customer, attributes (such as company name, number of employees, stated capital, and whether listed on stock market) of organizations that respective customers are affiliated with, attributes (such as monetary amount and type) of products, and attributes (such as sales, location, and category) of stores that handle the products, and stores the information in the node database 40. In addition, as information regarding each edge in the graph data, the graph data generation unit 20 extracts, from the input information, information such as relatedness between each customer and a related person, an organization, or a product, and stores this information in the edge database 50. As a result, graph data representing features of customers who use credit cards or loans is generated and stored in the graph database 30.

The financial risk estimation unit 130B estimates a financial risk (credit risk) for each customer on the basis of a node feature vector inputted from the node feature vector obtainment unit 120. Here, as described above, the spatiotemporal feature vector calculated by the spatiotemporal feature vector calculation unit 110 has been reflected to a node feature vector inputted from the node feature vector obtainment unit 120. In other words, the financial risk estimation unit 130B estimates a monetary risk for each customer on the basis of the spatiotemporal feature vector calculated by the spatiotemporal feature vector calculation unit 110. The financial risk estimation unit 130B stores a risk estimation result for each customer in the risk saving unit 140B.

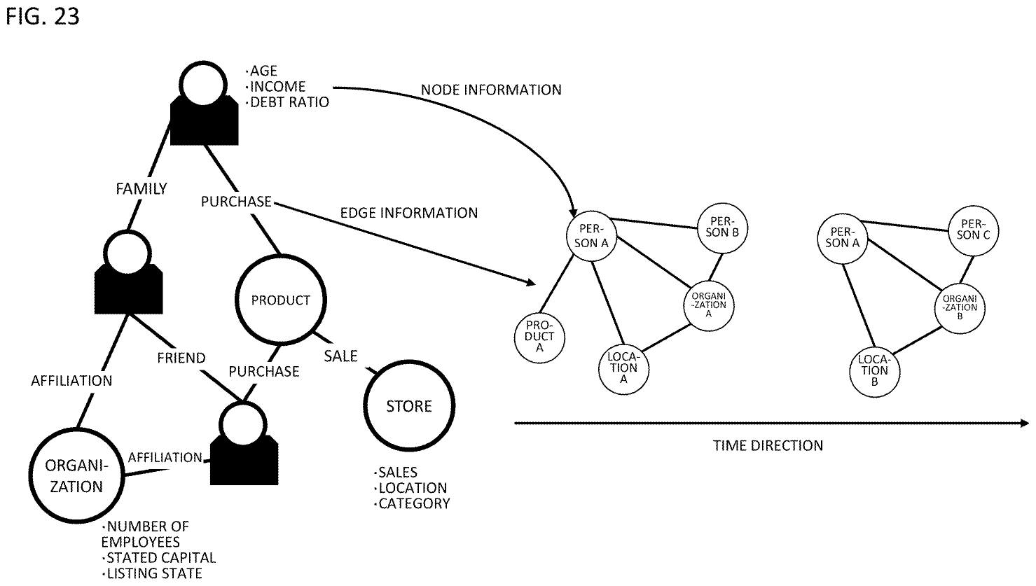

FIG. 23 is a view that illustrates an outline of processing performed by the graph data generation unit 20 in the financial risk management system 1B according to the third embodiment of the present invention. As illustrated in FIG. 23, the graph data generation unit 20 obtains, as node information, information such as the age, income, or debt ratio which represent attributes of respective customers or related person therefor, information such as the number of employees, stated capital, and listing state which represent attributes of an organization respective customers are affiliated with, and information such as sales, location, and category which represent attributes of a store that handles a financial product. In addition, information such as friends or family representing relatedness between a customer and a related person, or information representing relatedness between respective customers and an organization or a product is obtained as edge information. On the basis of these obtained items of information, graph data that includes a plurality of nodes and edges is generated every certain time section At. In this graph data, for example, respective customers or related persons thereof (people), organizations, products, and locations (stores) are each represented as nodes, and attribute information represented by the obtained node information is set to the respective nodes. Edges having edge information representing respective relatedness are set between respective nodes. Information regarding graph data generated in this manner is stored in the graph database 30.

Instead of just a status at the current time for a corresponding evaluation target, referring also to a previous status can be considered for estimation of a financial risk. When faience acts by an evaluation target are represented in a graph constructed by the method described above, because it is possible for the graph structure to dynamically change in time series, a dynamic graph analysis method in which a structure changes in time series is required. Accordingly, in a case where the structure of graph data dynamically changes in the time direction, means for effectively obtaining a change in node feature vector which corresponds thereto is required, and application of the present invention is desirable.

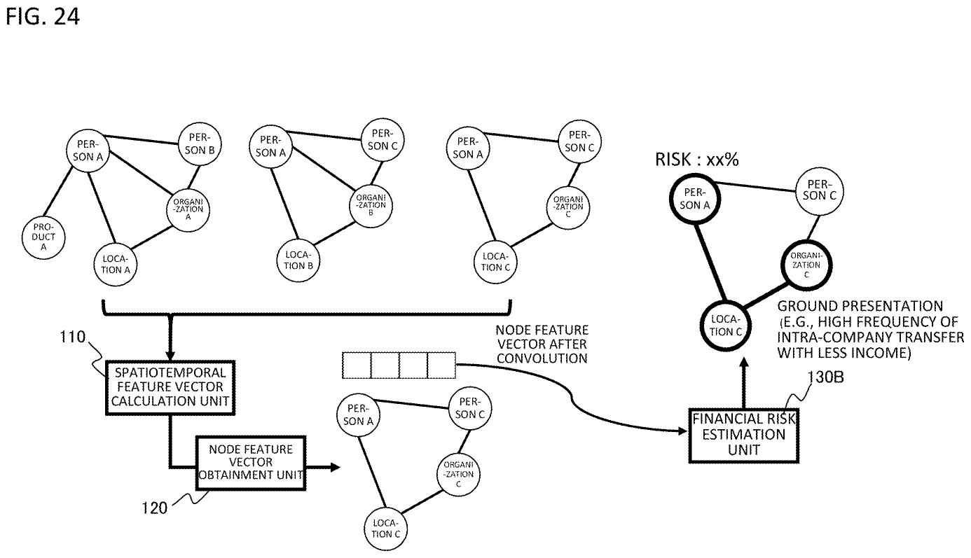

FIG. 24 is a view that illustrates an outline of processing performed by the spatiotemporal feature vector calculation unit 110 and the financial risk estimation unit 130B in the financial risk management system 1B according to the third embodiment of the present invention. As illustrated in FIG. 23, on the basis of a node feature vector and an edge feature vector individually extracted from graph data, the spatiotemporal feature vector calculation unit 110 performs a convolution computation in each of the space direction and the time direction for each node to thereby reflect the spatiotemporal feature vector to a feature vector for each node. The feature vector which is for each node and to which the spatiotemporal feature vector has been reflected is obtained by the node feature vector obtainment unit 120 and inputted to the financial risk estimation unit 130B. On the basis of the feature vector for each node inputted from the node feature vector obtainment unit 120, the financial risk estimation unit 130B, for example, performs regression analysis or obtains a reliability for a binary classification result that corresponds to the presence or absence of a risk, to thereby calculate a risk estimation value pertaining to a financial risk for each customer.

The risk estimation value calculated by the financial risk estimation unit 130B is stored to the risk saving unit 140B and also presented to a user in a predetermined form by the determination ground presentation unit 150. Furthermore, at this point, as illustrated in FIG. 24, it may be that a node for which the risk estimation value is greater than or equal to a predetermined value and an edge connected to this node are subjected to an emphasized display, and an estimated cause (for example, a customer having a high risk estimation value has a high frequency of an intra-company transfer resulting in income decreasing) is presented as a determination ground.

In the present embodiment, description has been given for an example of application to the financial risk management system 1B that performs customer management by estimating a monetary risk for a customer who uses a credit card or a loan, but it is possible to have application to an apparatus that is inputted with each customer or information relating thereto and performs similar processing on these items of input data. In other words, the financial risk management system 1B according to the present embodiment may be reworded as a data analysis apparatus 1B.

By virtue of the third embodiment of the present invention described above, a node in graph data represents attributes of any of a product, a customer who has purchased the product, a related person having relatedness with respect to the customer, an organization to which the customer is affiliated, or a facility pertaining to the product, and an edge in the graph data represents any of relatedness between a customer and a related person or an affiliated organization, purchase of a product by a customer, or relatedness between a facility and a product. Thus, it is possible to appropriately represent, in graph data, monetary features of a customer who uses a credit card or a loan.

In addition, by virtue of the third embodiment of the present invention, the data analysis apparatus 1B is provided with the financial risk estimation unit 130B which estimates a monetary risk for a customer on the basis of a spatiotemporal feature vector calculated by the spatiotemporal feature vector calculation unit 110. Thus, it is possible to reliably discover a customer for which a monetary risk is high.

Note that the present invention is not limited to the embodiments described above, and can be worked using any component in a scope that does not deviate from the spirit thereof. The embodiments or various modifications described above are purely examples, and the present invention is not limited to the contents of the above-described embodiments or modifications to an extent that the features of the invention are not impaired. In addition, various embodiments or modifications have been described above, but the present invention is not limited to the contents of these embodiments or modifications. Other aspects which can be considered to be within the scope of the technical concept of the present invention are also included in the scope of the present invention.

### DESCRIPTION OF REFERENCE SYMBOLS

1: Anomaly detection system (data analysis apparatus)
1A: Sensor failure estimation system (data analysis apparatus)
1B: Financial risk management system (data analysis apparatus)
10: Camera moving image input unit
10A: Sensor information obtainment unit
10B: Customer information obtainment unit
20: Graph data generation unit
30: Graph database
40: Node database
50: Edge database
60: Graph data visualization editing unit
70: Node feature vector extraction unit
80: Edge feature vector extraction unit
90: Node feature vector accumulation unit
100: Edge feature vector accumulation unit
110: Spatiotemporal feature vector calculation unit
120: Node feature vector obtainment unit
130: Anomaly detection unit
130A: Failure rate prediction unit
130B: Financial risk estimation unit
140: Threat indication level saving unit
140A: Failure rate saving unit
140B: Risk saving unit
150: Determination ground presentation unit
160: Element contribution level saving unit

1. A data analysis apparatus comprising:
a graph data generation unit configured to generate, in chronological order, a plurality of items of graph data configured by combining a plurality of nodes representing attributes for each element and a plurality of edges representing relatedness between the plurality of nodes;
a node feature vector extraction unit configured to extract a node feature vector for each of the plurality of nodes;
an edge feature vector extraction unit configured to extract an edge feature vector for each of the plurality of edges; and
a spatiotemporal feature vector calculation unit configured to calculate a spatiotemporal feature vector indicating a change in the node feature vector by performing, on the plurality of items of graph data generated by the graph data generation unit, convolution processing for each of a space direction and a time direction on a basis of the node feature vector and the edge feature vector.

2. The data analysis apparatus according to claim 1, wherein
the nodes represent attributes of a person or object appearing in a video or image obtained by capturing a predetermined location to be monitored, and
the edges represent an action that the person performs with respect to another person appearing in the video or image, or the object.

3. The data analysis apparatus according to claim 2, further comprising:
an anomaly detection unit configured to detect an anomaly in the location to be monitored, on a basis of the spatiotemporal feature vector calculated by the spatiotemporal feature vector calculation unit.

4. The data analysis apparatus according to claim 1, wherein
the nodes represent attributes of sensors installed at predetermined locations, and
the edges represent a speed of communication performed between one of the sensors and another of the sensors.

5. The data analysis apparatus according to claim 4, further comprising:
a failure rate prediction unit configured to predict a failure rate for the sensors on a basis of the spatiotemporal feature vector calculated by the spatiotemporal feature vector calculation unit.

6. The data analysis apparatus according to claim 1, wherein
the nodes represent attributes of any of a product, a customer who has purchased the product, a related person having relatedness with respect to the customer, an organization to which the customer is affiliated, or a facility pertaining to the product, and
the edges represent any of relatedness between the customer and the related person or the affiliated organization, purchase of the product by the customer, or relatedness between the facility and the product.

7. The data analysis apparatus according to claim 6, further comprising:
a financial risk estimation unit configured to estimate a monetary risk for the customer on a basis of the spatiotemporal feature vector calculated by the spatiotemporal feature vector calculation unit.

8. A data analysis method that uses a computer to execute:
a process for generating, in chronological order, a plurality of items of graph data configured by combining a plurality of nodes representing attributes for each element and a plurality of edges representing relatedness between the plurality of nodes;
a process for extracting a node feature vector for each of the plurality of nodes;
a process for extracting an edge feature vector for each of the plurality of edges; and
a process for calculating a spatiotemporal feature vector indicating a change in node feature vector by performing, on the plurality of items of graph data, convolution processing for each of a space direction and a time direction on a basis of the node feature vector and the edge feature vector.
